(19) United States
(12) Patent Application Publication
(10) Pub. No.: US 2002/0091782 A1
(43) Pub. Date: Jul. 11, 2002

(54) Method for certifying and unifying delivery of electronic packages

(76) Inventor: Charles F. Benninghoff III, San Juan Capistrano, CA (US)

Correspondence Address: Joseph C. Andras, MYERS DAWES & ANDRAS LLP, Suite 1150, 19900 MacArthur Blvd., Irvine, CA, 92612, US

(21) Appl. No.: 10/042,670

(22) Filed: Jan. 9, 2002

Related U.S. Application Data
(60) Provisional application No. 60/260,764, filed on Jan. 9, 2001.
(60) Provisional application No. 60/340,666, filed on Dec. 7, 2001.

(51) Int. Cl. G06F 15/16; G06F 17/60; H04L 9/00; H04K 1/00

(52) U.S. Cl. 709/206; 705/75; 713/175

(57) ABSTRACT

A method of verifiably transmitting an Electronic Package (20), such as an email and associated attachments, from a sender (600) to a recipient (700) through the system (10) that is a certifying authority via a public communications network. The method involves the steps of receiving (140) an Electronic Package (20) that is transmitted from the sender (600) to the System (10) via the public communications network; storing (150) particulars relating to the Electronic Package (20) on a server (100) operated by the certifying authority for use in later verifying the particulars relating to the Electronic Package (20); delivering (160) the Electronic Package (20) from the certifying authority to the recipient (700) via the public communications network; and generating (170, 171) an encrypted hash value (120) based on the particulars (111, 112) that relates the Electronic Package (20) and the delivery thereof and that uniquely identifies the particulars (111, 112) relating to the Electronic Package and the delivery thereof; creating (170, 171) an Electronic Certificate of Service (110) that contains the particulars (111, 112) and the encrypted hash value (120), and transmitting (170, 172) ) the Electronic Certificate Of Service (110) from the certifying authority via the public communications network, and providing a method and device for subsequent testing said hash (120) to provide that the particulars (111, 112) represented are the same as actually occurred. In an alternative aspect, disclosed is a method and system for simultaneous Submission and Transmission of Electronic Packages (20) utilizing the World Wide Web.

### CROSS-REFERENCE TO RELATED APPLICATIONS

This application claims the benefit of provisional patent application no. 60/260,764 filed on Jan. 9, 2001 and of provisional patent application no. 60/340,666 filed on Dec. 7, 2001.

### BACKGROUND

1. Field of Invention

This invention relates generally to a unitary system for the delivery of Electronic Packages, such as email messages and attachments that are attached to the message, and describes: (a) a method and apparatus that provides a sender of email a unique and novel independent service to prove that the message and documents attached to the email, if any, were transmitted and received by the intended recipient, and to provide a duplicate thereof upon query; and (b) a computer method and system for Submission and Transmission of an Electronic Packages (“EP”) pursuant to varying format requirements and serving the same EP and, additionally, transmittal information.

2. Description of Related Art

Although there are numerous patents involving email, none of the patents known to this inventor disclose a method and apparatus under which an independent entity stands as a certifying authority for the fact that an Electronic Package was transmitted by a named person and received by a named person, all as set forth in this patent application. Further, the inventor is unaware of any patent that provided for the unitary delivery of Electronic Packages.

Many callings require that a document be transmitted to a recipient and that the transmission be attested to. For example, in the medical field, a medical staff must transmit claims to an insurance company based upon services rendered on behalf of the company's insured. In the legal field, documents must be served upon parties, and a court, and proof must be available of the transmission. In contract negotiations, or in contract fulfillment where time may be of the essence, not only the transmission must be authenticated but, also, the delivery. Many other instances abound where transmission, and/or delivery, of a particular document must be provable by some means independent of the transmitter's own oath. In the legal field, for example, a “Proof of Service” (herein “PoS”) is required in an overwhelming majority of jurisdictions when a document is served upon an opposing party. This PoS traditionally takes the form of a Declaration under penalty of perjury, made by someone not a party to the action, that upon a certain date, in a certain place and time, that the declaring person delivered named documents to a designated person utilizing a specified mode of transmission. The same is equally true in such disparate activities as filing of an income tax return, or the placement of a bid in an online auction.

Nowhere on the internet is there found any independent system to accomplish electronically what the classical PoS accomplished, namely that an independent person attests to the transmission of specified documents to a specified party, etc.

Not until PoS-e, that is. Now, with PoS-e any person can with the click of a button generate all of the necessary steps to prove not only transmission, but also delivery, of specifically-named and identifiable documents.

The World Wide Web (“sometimes hereafter WWW”) is comprised of a vast assortment of personal computers, servers, software platforms, browsers and email clients (herein “elements”). All of this assortment is nevertheless interconnected through the WWW in a manner so that each might communicate with the other compatible elements through the channels each is dedicated to serve. Thus, a person (herein “Sender”) can seek to submit a message, document, or file, (herein “Electronic Package” or “EP”) to another person (herein “Organization”) utilizing the WWW and in doing so can run afoul of the dedicated conventions of the particular elements involved in transmitting, storing, or receiving the EP. Compounding this complexity is the trait in most Submission/Transmission schema that, in addition to the person to whom the EP is to be submitted, there may be numerous other persons with whom copies of the EP are desired, or required, (herein “Recipients”) to be transmitted. In the second half of this Submission/Transmission equation, the variety of the platforms utilized by the Recipients can be as varied as their number.

For example, but without any limitation of the current invention's applicability, in current schemas employed over the WWW for submitting documents with government systems, the currently universal Application Process Interface (“API”) is a native format to Extensible Markup Language (“XML”) converter. Additionally, each jurisdiction, or agency within a jurisdiction, may require different XML tags and conversion routines from the API. There is no known provision for serving on Recipients the XML EPs that are so converted for Submission to the particular Organization.

The native format EP may consist of a Unitary file format, or multiple formats. For example, a Unitary EP may consist of an MS WORD file, a portable document format (PDF) file, a TIFF, and a proprietary format file required by a particular Organization. The XML API converter paradigm may process this disparate file grouping and convert it to the particular XML schema dictated by the Organization chosen by the Sender, or it may require a particular file format for all elements of the EP to be submitted to the API at the outset. Other variations may occur from Organization-to-Organization.

An XML EP has both a logical and a physical structure. Physically, the EP is composed of units called entities. An entity may refer to other entities to cause their inclusion in the EP. An EP begins in a “root” entity. Logically, the EP is composed of declarations, elements, comments, character references, and processing instructions, all of which are indicated in the EP by explicit markup tagging. The logical and physical structures must nest properly. An XML EP processor is used to read XML EPs and provide access to their content and structure.

The WWW is especially conducive to promoting “paper-less” Submissions of EPs and that art is in its infancy nationwide. The current art is somewhat developed when the EP Submission is the sole subject of concern; however (and as noted above) Submission is just one-half of the equation. The other half is service of the EP upon interested, or required, Recipients. The general purpose of the within invention is to provide a unified format to accomplish the entirety of the Transmission.

Since the Sender's EP may contain highly sensitive data, all three Parties (the Sender, Organization and Recipient) may want to ensure the security of such information. Security is a concern because information transmitted over the Internet may pass through various intermediate computer systems on its way to its final destination. The information could be intercepted by an unscrupulous person at an intermediate system. To help ensure the security of the sensitive information, various encryption techniques are used when transmitting such information between a Sender's computer system and a server computer system. Even though such encrypted information can be intercepted, because the information is encrypted, it is generally useless to the interceptor. Nevertheless, there is always a possibility that such sensitive information may be successfully decrypted by the interceptor. Therefore, it would be desirable to minimize the sensitive information transmitted when a Submission occurs.

Additionally, and although there may be no legal requirement by a particular Organization, it may be appropriate to establish by spontaneous creation an encrypted digital signature uniquely appropriate to the Submission-Transmission transaction. Under the federal Electronic Signatures in Global and National Commerce Act a presumption is created as to the validity of a digitally signed transaction so long as the statute's safeguards are observed. Several States, as well, have enacted statutes regarding the efficacy of digitally signed transactions. Accordingly, the creation of a digital signature for a transaction may be of substantial benefit.

Of particular interest in transferring files through the WWW is the universal challenge of computer viruses, so-called Trojan horses, and Worms. These challenges can, by nefarious design, embed themselves into otherwise innocent files such as (and, perhaps, particularly) Microsoft WORD and Excel files that contain macros, or other executable functions. Modern anti-virus systems abound for the protection of the Recipient computer systems and, also universally, these anti-virus systems will provide for automatic stripping of an infected attached file from a message, letting the uninfected balance flow through to the hard drive of the Recipient. Thus denuded of its intended cargo, the received message is of no value. A unique and nonobvious system is set forth herein whereby the infected file may nevertheless be salvaged by the Recipient without input, or assistance of any type, from the Sender; and said system can discern if the Recipient's computer operating system is java enabled (and thus utilize a proprietary applet-driven download of the file), or not and, if not, offer the Recipient the choice to receive the rendered file by direct download or through the email.

### DEFINITIONS

The following definitions will apply throughout this patent application:

ALN Array of Logical Nomenclatures is an assemblage of designated elections of Organization(s) and/or Recipient(s) in a manner, and style, whereby the Sender can commit to consummating a Transaction by selecting one of the arrayed collected entries.

Certificate A Certificate is either (a) Electronic, or (b) Physical.

CERTIFYING AUTHORITY is the group of PoS-e personnel who audit a Secure File Storage Server 400 pursuant to a Requisition for the production of a Physical Certificate and a duplicate of a Message and Attachment(s), if any, and preferably consists of the Chief of Information Technology, the Chief Operating Officer and the Custodian of Records.

CORE—Is a “Collected Organization/Recipient Entry”; i.e., an automated association made by the EPS when a Sender links an Organization with particular Recipient(s) in completing a Transaction.

Electronic Certificate An Electronic Certificate (“ES”)(is automatically sent after a message has been transmitted through the servers of PoS-e, and said ES is electronically delivered to both the sender and the recipient.

Electronically—Electronically means to be sent, or received, over the world wide web.

Entitled Person An Entitled Person is either the sender or recipient, or any other person authorized under applicable law, to receive a copy of the Certificate issued by the Responsible Person.

EP—an “Electronic Package” consisting of internet packets arising from transmitting disparate file types over the WWW.

EPS—Electronic Package System, the current invention, which is a system as defined, illuminated and described herein.

GUI A GUI is a “graphical user interface”, or the part of a computer program by which a user may exploit the features built into the underlying software program.

In Camera Key (herein sometimes the “ICK”) is the encrypted key maintained solely by the Certifying Authority and with which the Digital Certificate embedded into the Electronic Certificate is prepared as described herein.

ISP is an abbreviation for an Internet Service Provider, such as America On Line, Juno, MSN, etc.

LN—See “Logical Nomenclature”.

Logical Nomenclature—EPS will generate a GUI dialogue response to the election of an Organization and/or Recipient(s) with a request to name the respective Transaction and the name so provided is nomenclature logical to the Sender, as it was designated thereby.

Organization—An Organization can be a government agency, a for-profit enterprise, or any other person that accepts the Submission of an EP over the WWW.

Organization Book—An assemblage of Organizations arrayed by name only. When selected by a Sender, the EPS automatically Submits the EP to the Organization in the style, and format, required by the Organization, and any designed Recipients, without encumbering the Sender in any way.

Physical Certificate A Physical Certificate is a physical document prepared by a Responsible Person in response to a Requisition for the same by an Entitled Person.

PoS—The traditional mail, or courier, method whereby a person (generally following a statute's requirements, self-prepares a declaration under penalty of perjury, that said person transmitted certain named documents, or things, to the indicated recipient, at a certain time, date and place, utilizing a defined delivery method, such as mail, hand delivery, facsimile delivery, etc. The transmitting Declarant may be closely associated with the transaction, and in many cases, the independence thereof is subject to grave question. Generally known as a “Proof of Service”.

PoS-e—The electronic derivative and enhancement of the PoS, as described in this patent application, differing substantially from the traditional PoS in that the PoS-e service is provided by a totally independent person.

Recipient—A Recipient is a person who is designated to receive a copy of an EP that is submitted to an Organization. Transmission of an EP may be consensual, or may be required by operation of a statute, court or administrative rule, agreement, or otherwise.

Recipient Book—An assemblage of the identifying data pertaining to each Recipient as may be required to Transmit an EP and, at the same time, comport with any Recipient data requirements instituted by a selected Organization.

Rendering—the EPS can be instructed by the Sender to render a file from a native format (e.g. Microsoft WORD, Novel WordPerfect, Adobe Illustrator, TIFF, etc.) to a secondary format (e.g., XML, TIFF, PDF, etc.) for the purpose of Submission and Transmission.

Requisition is a formalized process for obtaining a Physical Certificate and a duplicate of any Message and Attachment(s), if any, and is able to be effected only by an Entitled Person upon the payment of the agreed-upon costs and fees.

Responsible Person A Responsible Person of PoS-e is an employee, agent, or officer in the regular employ of PoS-e who has been charged with the responsibility of researching the logs, and records, of PoS-e, verifying the sending of a particular message, and any stored data or files, and providing a Declaration sworn to be true and correct under the penalty of perjury, to either the recipient or sender, or any other person authorized under the law.

Sender—A Sender is a person that initiates the Submission, or Transmission, of an EP.

Sender Identification Format—See “SIF”.

Sender's System—The system employed by EPS for a Sender is comprised of a log inscription of unique data associated with each Sender, that Sender's predetermined Organization criteria and Recipient Transmission information, and an accretive database that perpetuates associations between Organization(s) and Recipient(s) so that subsequent CORE transactions may be accomplished by a unitary act.

Services of PoS-e When used herein, the term “Services of PoS-e” includes a preferred embodiment of the invention which is the subject matter of this patent application, which is generally the provision of a service whereby PoS-e records the transmission of a message, and/or attached files, as more fully set forth herein. The Services of PoS-e are obtainable in two manners: (a) through a browser-based version wherein all of the interaction between a user and PoS-e occurs within the GUI of a web page; and (b) through an email client-based version wherein all of the interaction between a user and PoS-e occurs within the GUI of the client through the placement in said interface of an addressable button, placed there by the means of an executable software program entitled “PoS-e Email Client Software”, which software provides to the user all of the functionality obtainable through the web-based browser service.

SIF—Sender Identification Format—A unique identifier assigned by the EPS server to each Sender. The SIF may be amended by the Sender.

Submission—When an EP is sent to an Organization, the sending thereto is referred to herein as a “Submission” because the sending usually, although not always, follows the rules, regulations and/or procedures established by the Organization, and the receipt thereof by the Organization requires either its implied, or actual, assent.

Subscriber A User may be a Subscriber if said User current in financial obligations and/or possessing sufficient credit. All Subscribers are Users.

Subscription Period is that period of time agreed upon by the Subscriber at the time the original message and attachment(s), if any, are sent, or as may be extended subsequently thereto by a subsequent agreement between PoS-e and any Entitled Person.

TOS The term TOS refers to Terms of Service, or the terms under which PoS-e provides the services which include, but are not limited to, the invention described herein.

Transaction—A transaction for the purposes set forth herein includes the initiation of a message, the assemblage of disparate files as attachments, Rendering of the attachments, Submission to an Organization and Transmission to designated Recipients.

Transmission—When an EP is sent to a Recipient, the sending thereto is referred to herein as a “Transmission” because the sending usually, although not always, follows the rules, regulations and/or procedures established by the respective Organization associated with the transaction.

Unitary Action—A voluntary decision made by the Sender to select a CORE entry in an ALN.

User Any person who has completed the application to use the PoS-e system may be a User, whether, or not, that person is current in her financial obligations.

### SUMMARY OF THE INVENTION

In one aspect, the present invention may be regarded as a method for verifiably transmitting an electronic package from a sender to a recipient through a certifying authority via a public communications network, the method comprising the steps of: receiving an electronic package that is transmitted from the sender to the certifying authority via the public communications network; generating an encrypted hash value based on particulars surrounding the electronic package, the encrypted hash value uniquely identifying said particulars; storing the electronic package and the encrypted hash value on a server operated by the certifying authority for use in later verifying the particulars surrounding the electronic package; delivering the electronic package from the certifying authority to the recipient via the public communications network; and transmitting an electronic certificate of service from the certifying authority via the public communications network, the electronic certificate of service including the particulars of the electronic package and the encrypted hash value as verification of the content and delivery of the electronic package from the certifying authority to the recipient.

As to the first aspect of this invention, one preferred embodiment comprises a system and apparatus to enable a sender of documents through email to prove not only the sending, but also all pertinent details appurtenant thereto, is disclosed. The system for initiating transmission, transmitting, maintaining a queryable database of transmission details, and storing duplicate(s) of the transmitted document(s) is also disclosed. An exemplary method includes: (1) Making available to a person who subscribes to the PoS-e service the ability to securely utilize either (a) her email client, or (b) a web-based email system, to assemble an email transmission consisting of (i) a message and (ii) documents to be attached to said message, to select prior to transmission of said message and attachments, to use the invention herein disclosed (herein referred to as “PoS-e”); (2) Making available to said person, at the time of selecting, the option to have the PoS-e system retain a duplicate of the attached document(s), if any, and/or the transmitted message; (3) Transmitting to the sender and recipient a PoS-e Declaration of Service which is printable by the sender or recipient; (4) Making available to either sender, or recipient, or a lawfully-entitled third person, at a date uncertain a duplicate of the PoS-e Declaration of Service; (5) Making available to either sender, or recipient, or a lawfully-entitled third person, at a date uncertain a duplicate of the attached documents elected by the sender to be retained at the PoS-e server; (6) Making available to sender the option to encrypt the message and the attachment(s) utilizing strong encryption; (7) Making available to the sender proof that the documents sent to the recipient were delivered to the recipient. The disclosed embodiment, which is a possible embodiment of a plurality of potential embodiments, allows a subscriber of the PoS-e services described herein to prove beyond doubt not only the time and manner of transmitting documents to a designated recipient, but the exact documents so transmitted.

In another aspect, the invention provides a method and system for simultaneous Submission and Transmission of Electronic Packages utilizing the WWW. The Submission and Transmission utilizes a Sender's System and is received by a server system. The server system receives Submission and Transmission instructions including unique identifying information of the Sender, payment information, and Submission and Transmission instructions from the Sender's System. The server system then assigns a unique Sender Identification Format to the Sender's System and associates the assigned Sender Identification Format with the transmitted Submission and Transmission instructions, and generates a unique digital signature for the Sender that pertains to that Transmission. The server system sends to the Sender's System the assigned Sender Identification Format and an HTML document identifying the Submission and Transmission, and including a “Send” Transmission button. The Sender's System receives and stores the assigned Sender Identification Format and receives and displays said HTML document. In response to the selection of the Send button, the Sender's System sends to the server system instructions to transmit and submit the designated message and any attachment(s). The server system receives the Submission and Transmission instruction and combines the data associated with the Sender Identification Format to complete the service and Submission initiated by the Send button.

One object of the present invention is to provide a system and method whereby any person may cause to be transmitted electronically messages and files in electronic format.

Another object of the present invention is to provide a system and method whereby any person may caused to be transmitted electronically files in electronic format and register electronically with PoS-e the time, date, file size, sender, and recipient of said transmission.

Another object of the present invention is to provide a system and method whereby any person may caused to be transmitted electronically files in electronic format and register electronically with PoS-e the time, date, file size, sender, and recipient of said transmission and provide that a duplicate of transmitting message be stored on PoS-e's server for a designated period of time.

Another object of the present invention is to provide a system and method whereby any person may cause to be transmitted electronically files in electronic format and register electronically with PoS-e the time, date, file size, sender, and recipient of said transmission and provide that a duplicate of the transmitting message, and files transmitted, be stored on PoS-e's server for a designated period of time.

Another object of the present invention is to provide a system and method whereby any person may receive electronically a printable Electronic Certificate evidencing that PoS-e has received at its server a message to a named recipient, and has sent the indicated email address the message, and, further, that the said Electronic Certificate sets forth additional criteria such as, but not limited to, time and date of transmission, particulars on encryption utilized (if any), file size, and the number and size of attachment(s), if any.

Another object of the present invention is to provide a system and method whereby any Entitled Person may receive a Physical Certificate, sworn under penalty of perjury to be true and correct, made by a Responsible Person and evidencing those items set forth in the corresponding Electronic Certificate, and further, the period of time during which PoS-e retained said message.

Another object of the present invention is to provide a system and method whereby any Entitled Person may receive a Physical Certificate, sworn under penalty of perjury to be true and correct, made by a Responsible Person and evidencing those items set forth in the corresponding Electronic Certificate, and further, the period of time during which PoS-e retained said message and attachment(s).

Another object of the present invention is to provide a system and method whereby any Entitled Person may receive a Physical Certificate, sworn under penalty of perjury to be true and correct, made by a Responsible Person and evidencing those items set forth in the corresponding Electronic Certificate, and further, the period of time during which PoS-e retained said message and attachment(s), and provide an electronic duplicate of said message and attachment(s).

Another object of the present invention is to provide a system and method whereby any person may elect to utilize the Services of PoS-e by virtue of utilizing the PoS-e browser-based application, which application provides all of the Services of PoS-e.

Another object of the present invention is to provide a system and method whereby any person may elect to utilize the Services of PoS-e by virtue of having installed the email client software version of PoS-e, instead of a browser-based version, which email client version includes all of the Services of PoS-e addressable by clicking on a button on the face of the email GUI, which has been installed there by said software.

Accordingly, and in addition to the objects and advantages of the PoS-e Services, and the PoS-e internet and software-based applications described in my within patent, several objects and advantages of the present invention are, and include:

(a) providing to any Entitled Person an independent source to Certify the sending, contents, and receipt, of an Electronic Package;

(b) providing to any Entitled Person a Physical Certificate with which the sending of an Electronic Package, and its contents, may be proven;

(c) providing to any Entitled Person a process of transmitting, storing retrieving and producing a Physical Certificate to prove that the contents within an Electronic Package, e.g. an email message and attachment(s), if any, were thus communicated at a specific time, date and to a specific person.

(d) providing to any Entitled Person an independent process of proving an independent chain of possession of a particular Electronic Package, e.g. email message and its attachment(s), if any;

(e) providing to any Entitled Person on a pre-paid basis, the assurance of receiving for a set period of time the benefits outlined in this invention regarding an independent source of proof of the contents of an Electronic Package, e.g. an email message, and attachment(s), if any, and the time, date and person to whom the said message was delivered, pursuant to a Physical Certificate as set forth in this invention.

Another object of the present invention is to provide a system and method whereby any person (a “Sender”) may cause an EP to be Submitted to an Organization and Transmitted to any number of Recipients.

Another object of the present invention is to provide a system and method whereby any person (a “Sender”) may cause an EP to be Submitted to an Organization and Transmitted to any number of Recipients with the convenience of an Organization Book and/or a Recipient Book.

Another object of the present invention is to provide a system and method whereby any person (a “Sender”) may cause an EP to be Submitted to an Organization and Transmitted to any number of Recipients, with the simultaneous creation of a log entry embodying the collected details of the elections made pertaining to the transaction including, but not limited to, CORE selection(s), where the Collected Organization and Recipient Elections made by the Sender (CORE) are automatically stored, where the CORE is assigned Logical Nomenclature, where the Sender System arrays all available Logical Nomenclature, where the Sender selects a Logical Nomenclature by clicking on a button, where the Sender selects a Logical Nomenclature by producing a sound, and where the selection of a Logical Nomenclature by the sender results in the simultaneous Submission to the Organization and Transmission of the EP.

Another object of the present invention is to provide a method and system whereby a Recipient, upon being advised that a Transaction contains a virus, may proceed to the server delivering said Transaction and have the Submission and/or Transmission Rendered into a different format that precludes the Transmission of the virus, yet retains the characteristics thereof.

Another object of the present invention is to provide a method and system for a Sender to submit an EP with an Organization and, simultaneously, (a) transmit the EP upon designated Recipient(s), and (b) create an electronic signature for the Transaction of Submission and Transmission, with but a Unitary act on the part of the Sender.

Another object of the present invention is to provide a system that registers a unique identifier associated with the Sender that is utilized by the Sender to login to the system and access static personal information stored by the system server including such things as, but not limited to, personal identification information, Recipient data (e.g., an “Address Book”), payment information, occupational and/or professional affiliation(s), relational Submission data associated with specific Organizations.

Another object of the present invention is to provide a system that employs a web-browser based input page comprised of the following sections: Recipient(s), Organization Book, Recipient Book, Message Block, Attachment(s) and Description, Copy-To's (e.g., clients) and Format Rendering (such as XML, PDF, TIFF, etc.), in a unique and nonobvious manner.

Another object of the present invention is to provide a system that submits an EP in an electronic envelope (such as XML) generated pursuant to the requirements of an Organization's designated API for the particular Submission service envisioned, and simultaneously with the Submission Transmits said EP to Recipient(s) within the said envelope.

Another object of the present invention is to provide a system that simultaneously with the Submission, Transmits said EP to Recipient(s) in a format Rendered pursuant to the independent election of any of a plethora of Recipients.

Another object of the present invention is to provide a system that is accessible by the Recipient(s) via a web-browser based graphical user interface (GUI)

Another object of the present invention is to provide a system that provides a Recipient of a message a visual cue as to the status of a message as being read, or unread, through a Web Interface Page (WIP).

Another object of the present invention is to provide a system where a Recipient can send a reply to the Sender utilizing the Server System's EPS features.

Another object of the present invention is to provide a system where a Recipient can elect to download an EP either in the native format in which it was delivered to the Server System, or render said EP into a series of pdf files equal to the number of files in the EP, or aggregate said files into one pdf file.

Another object of the present invention is to provide a system where a Recipient can elect to store for an agreed upon term of years, sensitive information on the Server System in lieu of downloading the EP onto her local storage media.

Another object of the present invention is to provide a system that uses the SIF to discern if the operating system of the Recipient is java enabled for the purpose of allowing utilization of a proprietary applet, said applet automatically presenting a “download screen” to the Recipient, inquiring where on the storage media of Recipient a file should be stored, and after selection storing said file at said location and presenting to Recipient a status bar that plots the progress of the download process.

Another object of the present invention is to provide a system where, if it is determined by the SIF that the operating system of the Recipient is not java enabled, automatically presents to the Recipient a GUI that provides for the Recipient to elect to receive the file by direct download to a selected location on the storage media, or to receive said file as an attachment by email; and, upon selection, executing said election.

### BRIEF DESCRIPTION OF THE DRAWINGS

The just summarized invention may be best understood with reference to the drawings of which:

FIG. 1 is an overview of the presently preferred embodiment of the present invention, referred to herein as the PoS-e System 10, showing its internal modules and its external connections to a Subscriber and a Recipient.

FIG. 2 is a high-level flow chart showing the steps of the presently preferred method for receiving an Electronic Package 20 from a Sender, processing the particulars related to the transmission of the Electronic Package, delivering the Electronic Package 20 to the Recipient, and ultimately transmitting an associated electronic Certificate of Service 110.

FIG. 3 shows the preferred details associated with receiving the Electronic Package 20.

FIG. 4 the preferred details associated with processing the particulars related to the transmission of the Electronic Package.

FIG. 5 shows the preferred details associated with delivering the Electronic Package to the Recipient.

FIG. 6 shows the preferred details associated with creating and transmitting the Electronic Certificate of Service.

FIG. 7 shows the preferred web page 603W that is presented to a Sender who desires to send an Electronic Package 20.

FIG. 8 shows the preferred email confirmation 121 that the Server transmits to the Sender upon receiving the Electronic Package 20.

FIG. 9 shows the preferred email notification 122 that the Server transmits in order to notify the Recipient 700 that an Electronic Package 20 addressed to the Recipient is available on the Server 100.

FIG. 10 shows the Recipient Verification web page that is presented to the Recipient when they follow the HTML link in the email notification 130.

FIG. 11 shows the download webpage that is presented to the Recipient after being verified.

FIG. 12 is a physical presentation of the Electronic Certificate of Service and a facsimile of the corresponding Physical Certificate of Service.

FIG. 13 shows the delivery confirmation email that the Server sends to the Sender, along with the Electronic Certificate of Service as an attachment.

FIG. 14 shows the delivery confirmation email that the Server sends to the Recipient, along with the Electronic Certificate of Service as an attachment.

FIG. 15 is a representation of the process of a Future Query, wherein an Entitled Person at a future date unknown, but within the Subscription Period, is able to receive a Physical Certificate to prove the transmission of the message and attachment(s), if any, the person(s) to whom it was delivered and the physical contents.

FIG. 16 shows the message search page that is presented when a Responsible Person searches for a particular Electronic Package that is to be verified.

FIG. 17 shows the web page that is presented when a particular Certificate ID from the message search page of FIG. 16 is clicked, including the “signature checking” entry window.

FIG. 18 shows the “Signature is VALID” notice that is displayed when a valid encrypted hash value 120 has been inserted in the “signature checking” entry window and the “Check” button depressed.

FIG. 19 is an overview of the Server Functions

FIG. 20 is an illustration of the Sender's System including the SIF cookie

FIG. 21 is an illustration of the functioning of the Recipient System, including recapturing a stripped file

FIG. 22 is an illustration of the composition of the Sender's database requirements

FIG. 23 is an illustration of the composition of the Organization database, insofar as known for any particular Organization

FIG. 24 is an illustration of the database requirements for the Recipient(s)

FIG. 25 is an illustration of the web pages of the EPS system

FIG. 26 is an illustration of the API and Organization interface

FIG. 27 is an illustration of the Web Interface Page

### DETAILED DESCRIPTION OF THE PREFERRED EMBODIMENTS

Turning now to the drawings in detail, illustrated is one possible embodiment of a plurality of potential embodiments, of the present invention.

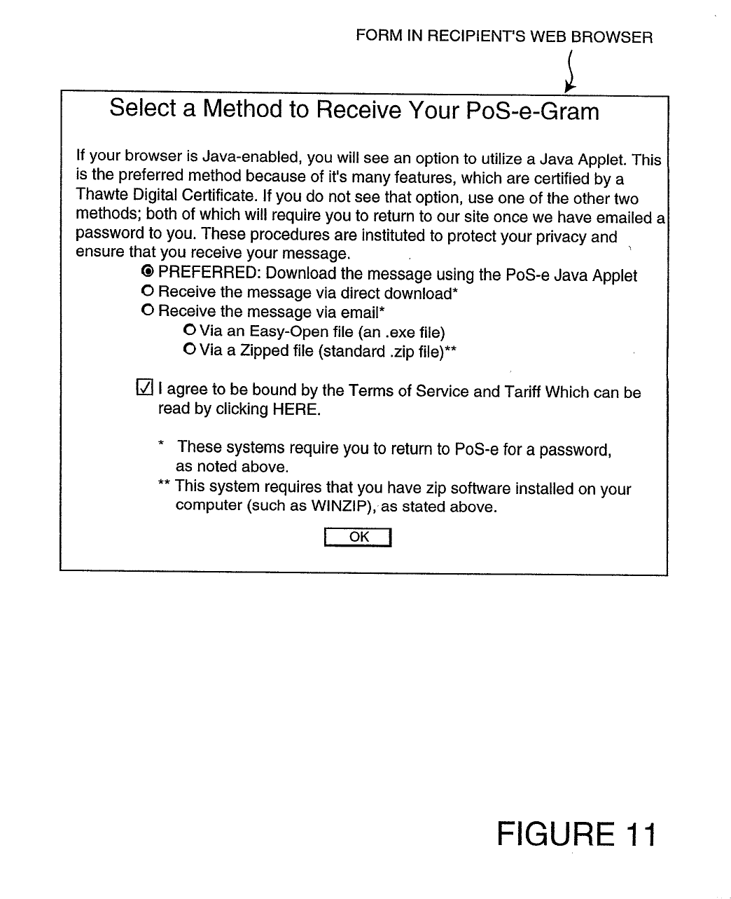

The preferred embodiment of the invention is a system 10 called “Proof of Service—electronic” and abbreviated as PoS-e (pronounced as in “posse”). The preferred PoS-e System 10 uniquely provides a totally independent electronic proof that an Electronic Package 20 (e.g. a particular email message and attachment(s), if any) has been delivered to a named Recipient. The preferred proof is provided in the form of an Electronic Certificate of Service 110 (see FIG. 12) that is provided to the Sender as a Subscriber of the PoS-e services, to the Recipient, and to other Sender designees (collectively “Entitled Persons”). Further, at a time in the future unknown, but within an agreed upon period, an “Entitled Person” may acquire from PoS-e not only hard copies of the Certificate, referred to as a Physical Certificate, but also electronic copies of the Electronic Package (e.g. email message and attachment(s), if any), along with a Certification by PoS-e of the exact details involved in the transaction and a verification that any electronic copies provided by PoS-e are true and correct and a further specification of the chain of possession of said electronic copies.

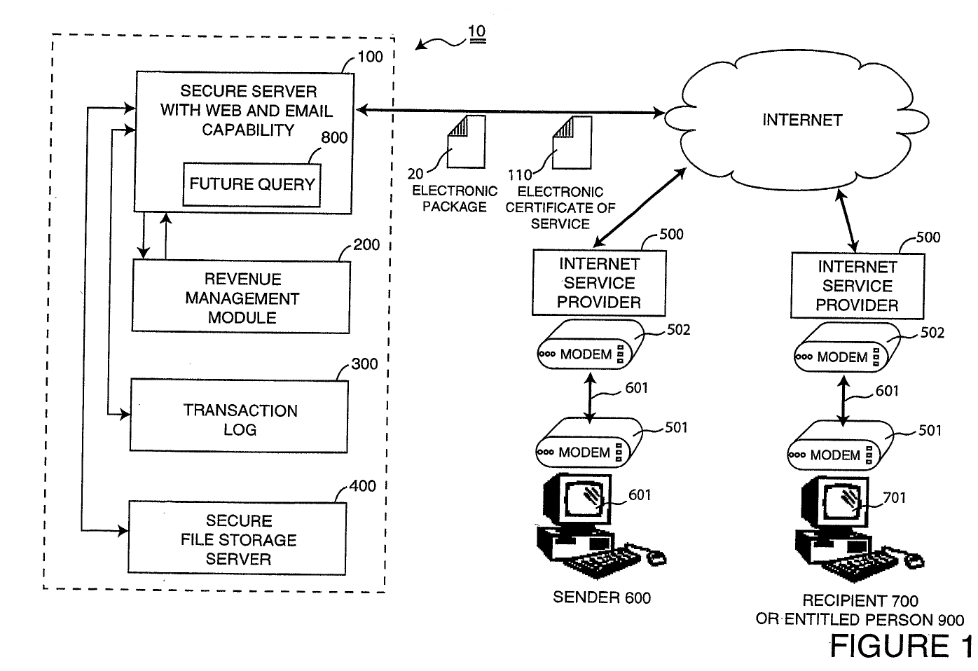

FIG. 1 is an overview of the presently preferred PoS-e System 10, including its internal modules and its external connection via the internet to a Subscriber 600 and a Recipient 700. FIG. 1 shows classic internet connections where the Subscriber 600 and the Recipient 700 use standard modems 501 to connect to modems 502 maintained by their ISPs 500. Other varieties of connectivity, of course, are possible.

As shown, the preferred PoS-e System 10 may generally be regarded as comprising four parts: (1) a Secure Server 100, (2) a Revenue Management Module 200, (3) a Transaction Logging Module that administers a Transaction Log 300, and (4) a Secure File Storage Server 400.

The Server 100 executes suitable server-side applications to control the overall operation of the System 10 and to provide both a web server and an email server for interfacing with Users such as a Sender 600 and a Recipient 700. The Revenue Management Module 200 is used to receive payment for services rendered. The Server 100 and Revenue Management Module 200 are cooperatively configured so as to permit an internet user to register as a Subscriber using a commonly accepted payment vehicle such as a credit card, a system such as PayPal, or other acceptable means for providing for interchange with a real-time payment facility within the Revenue Management Module 200. Revenue processing is well known and the precise details of the Revenue Management Module are not necessary to understand the preferred embodiment of the present invention.

The Transaction Log 300 is a repository for the data that is automatically retained by the System 10 or that the Sender's selects for retention, including the date and time of delivery, all of which is reflected on the Electronic Certificate of Service 110. The Transaction Log 300 is relied upon, therefore, for obtaining an Electronic Package 20 if PoS-e is queried at a later unknown date within a specified time period pursuant to a FUTURE QUERY 800. Further, it forms the basis upon which a Certification is made by the Certifying Authority of PoS-e. The file storage server 400, of course, is mass storage that is used by the System 10 to store an Electronic Package 20 for a designated period of time as may be automatically offered by the System 10 or selected by the Sender.

The preferred Server 100 interfaces with any adapted system which is widely deployed on the internet. The preferred PoS-e System 10, in other words, is not dependent upon any particular internet deployment or utilization scheme, such as Unix, Windows IIS, Linux, etc. This is possible because the PoS-e System 10 is a self-contained system based upon languages such as Java, C++, HTML, Visual Basic, and other similar software which are operating platform independent, or adaptable.

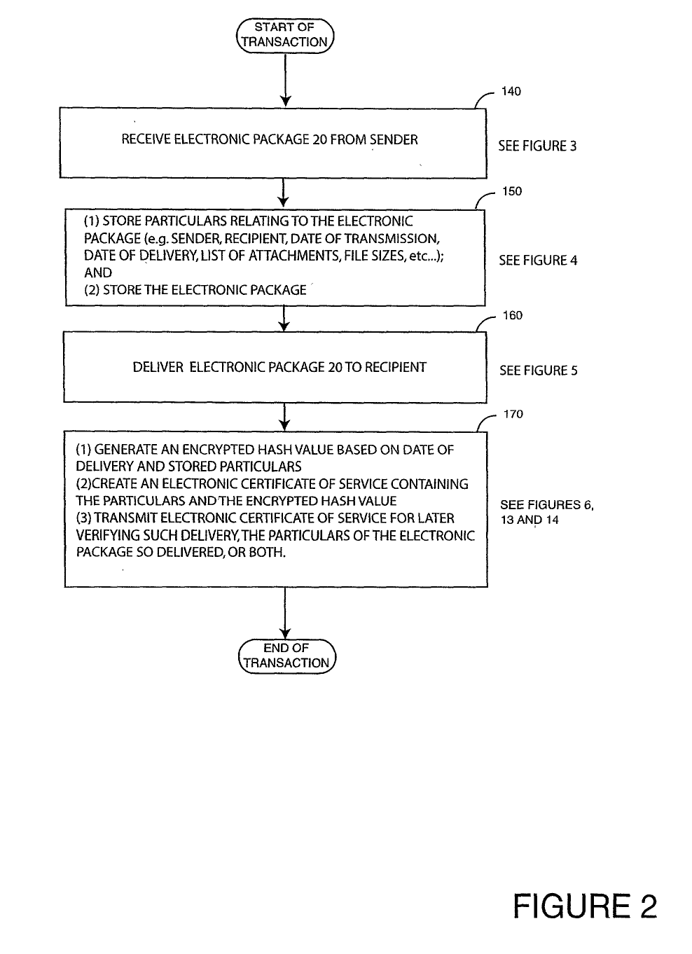

FIG. 2 is a high-level flow chart showing the steps of the presently preferred method for receiving, processing and delivering an Electronic Package 20 and an associated electronic Certificate of Service 110 (see FIGS. 1 and 12). At step 140, the System 10 receives the Electronic Package 20 from the Sender 600. At step 150, the System 10 stores the Electronic Package 20 and particulars related to the transmission thereof for later deliver and use in generating the Electronic Certificate of Service 110. In particular, the system (1) stores the Electronic Package 20 on the Secure File Server 400 and (2) stores particulars relating to the Electronic Package 20 and its transmission in the Transaction Log 300. The particulars are presently stored as a plurality of discrete record fields, but they may also be stored by way of a reversibly encrypted hash value, or through any other suitable manner. The typical particulars of interest include the identify of the Sender 600, the identify of the Recipient 700, the date and time of transmission, the date and time of delivery, the names of attachments and associated file sizes, etc. . . At step 160, the System 10 delivers the Electronic Package 20 to the Recipient 700. Finally, at step 170, the System 10 generates an encrypted hash value, creates the Electronic Certificate of Service 110 containing the particulars and the encrypted hash value, and transmits the Electronic Certificate of Service 110 for use in later verifying the fact of delivery of the Electronic Package, the particulars of the Electronic Package so delivered, or both. The details of the foregoing steps and further possible processing are revealed in the other figures and discussed further below.

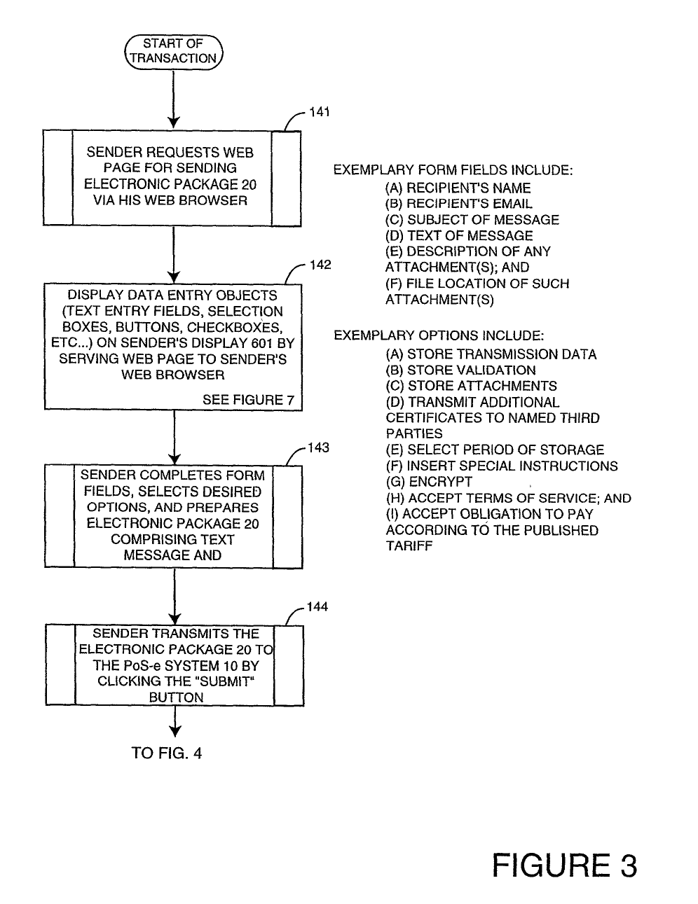

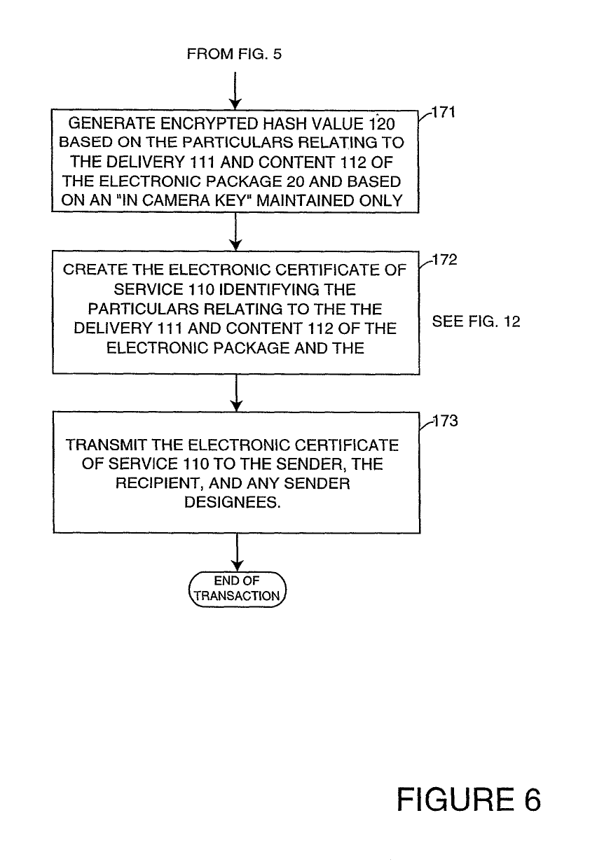

FIG. 3 shows the details associated with step 140 of FIG. 2, i.e. the receipt of an Electronic Package 20 from a Sender 600 for transmission to a Recipient 700 through the PoS-e System 10. Some of this discussion presumes that we have a hypothetical Sender named “Sam Sender”. At step 141, through his desktop, wireless, or other system 601 which is internet addressable, the Sender 600 is presented with data entry objects via suitable client-side application such as an HTML client application or an email client application. At step 142, via the Sender's client-side application, the System displays various PoS-e services that may be selected by the Sender as is appropriate to his circumstances. As shown in FIG. 7, the presently preferred System 10 displays the data entry objects via a web page that is displayed in the Sender's browser application. There would be little implementation difference between a browser application and an email application. At step 143, the Sender selects the desired services and options and prepares the Electronic Package 20 (i.e. the email message and attachment(s), if any). In the presently preferred embodiment, this step corresponds to the Sender's completion of the web page form as shown in FIG. 7 relating to a Electronic Package 20 that is being transmitted from Sam Sender to Rhonda Recipient. At step 144, the Sender 600 transmits the Electronic Package 20 to the PoS-e System 10 by simply pressing the “Send” button (see the bottom of FIG. 7).

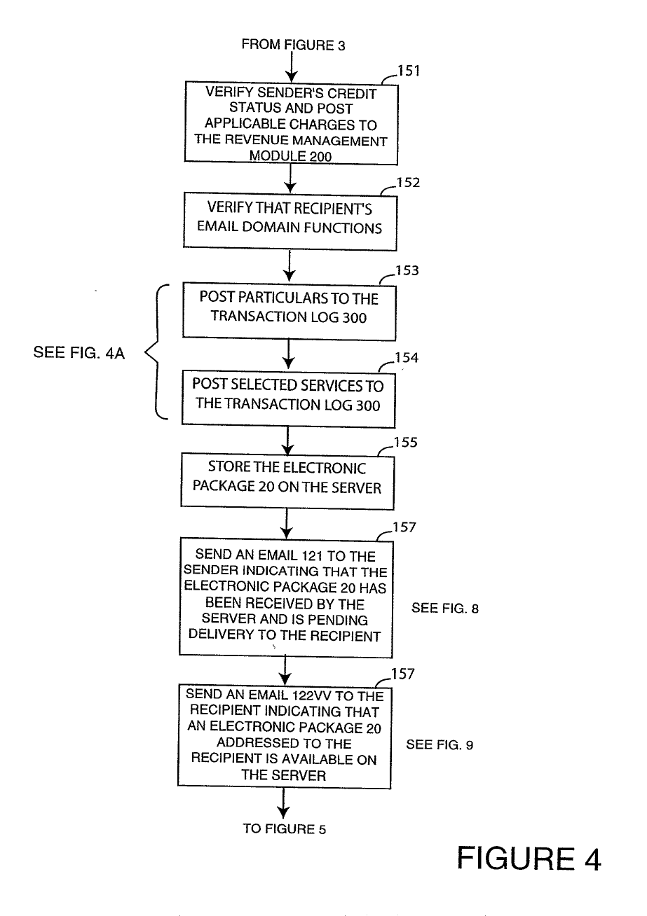

FIG. 4 shows the preferred details associated with step 150 of FIG. 2, i.e. the storing of the Electronic Package (here an email message and attachment(s), if any) after it is received by the PoS-e System 10 and processed by the Server 100. At step 151, the Server 100 verifies the credit status of the Sender 600 and, if it is, posts the appropriate charges to the Revenue Management Module 200. At step 152, the Server 100 pings the Recipient's domain to verify the existence of a valid email address.

At step 153, the Server 100 posts the particulars associated with the Electronic Package 20 to the Transaction Log 300. The preferred System 10 posts particulars regarding the Sender, the Recipient, the time, the date, the email addresses, and a list of attachments and associated file sizes, but more or less data particulars may be stored as a function of implementation.

At step 154, the Server 100 posts the particular services that were selected by the Sender in step 143 of FIG. 3 to the Transaction Log 300. The preferred System 10 posts entries regarding the following services: store messages; store attachments, transmit additional certificates to named third parties (designees), period of storage, special instructions, encryption, acceptance of terms of service (TOS), and acceptance of obligation to pay according to the published tariff. At step 155, the Server 100 stores the Electronic Package 20 on the File Server 400. The presently preferred System 10 stores the Electronic Package 20 without modification, but variations may be made. For example, the System 10 might be modified so that the Sender 600 is given the option to encrypt the Electronic Package 20 before storing it, transmitting it to a Recipient, or both.

FIG. 4A shows the presently preferred embodiment of the detailed data that is stored in the Transaction Log 300 and accessible pursuant to a Requisition by an Entitled Person 900.

As shown in step 153 of FIG. 4A, corresponding to the identically numbered step in FIG. 4, the Server 100 will post to the Transaction Log 300 such information as the name of the Sender 600, the name of the Recipient 700, the date and time of the Sender's transmission and/or deliver to the Recipient, the email addresses of the Recipient and designees, and a list of file name and attachment(s), if any. The Server 100 also assigns a set of unique identifiers, and computes a unique hash number for the particulars relating to the Electronic Package 20, and records that data in the Log 300. The unique identifiers are made available to the Sender and Recipient and designees so that they have identifying data sufficient to correlate at a future unknown time within the agreed-upon storage period the Electronic Packae 20 with the duplicate thereof stored on the Secure File Storage Server 400

As shown in step 154 of FIG. 4A, corresponding to the identically numbered step in FIG. 4, the Server 100 may also post additional data to the Transaction Log including, for example, the stored message, attachments, named third parties, period of storage, any special instructions inserted by the Subscriber 600, the acceptance of the Terms of Service, and acceptance by the Subscriber of her obligation to pay according to the published tariff.

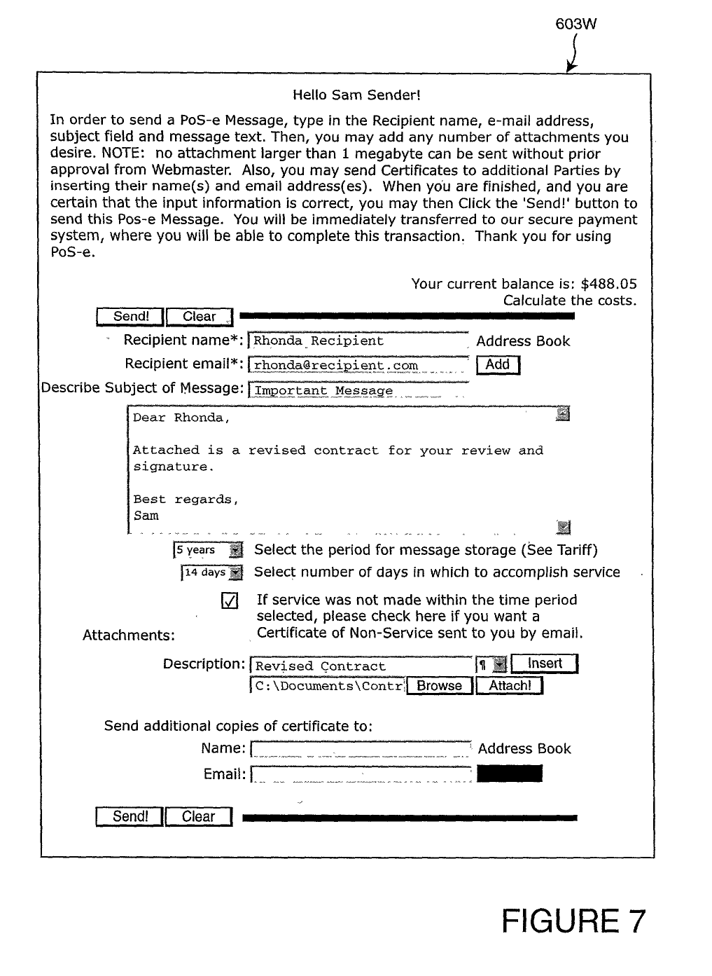

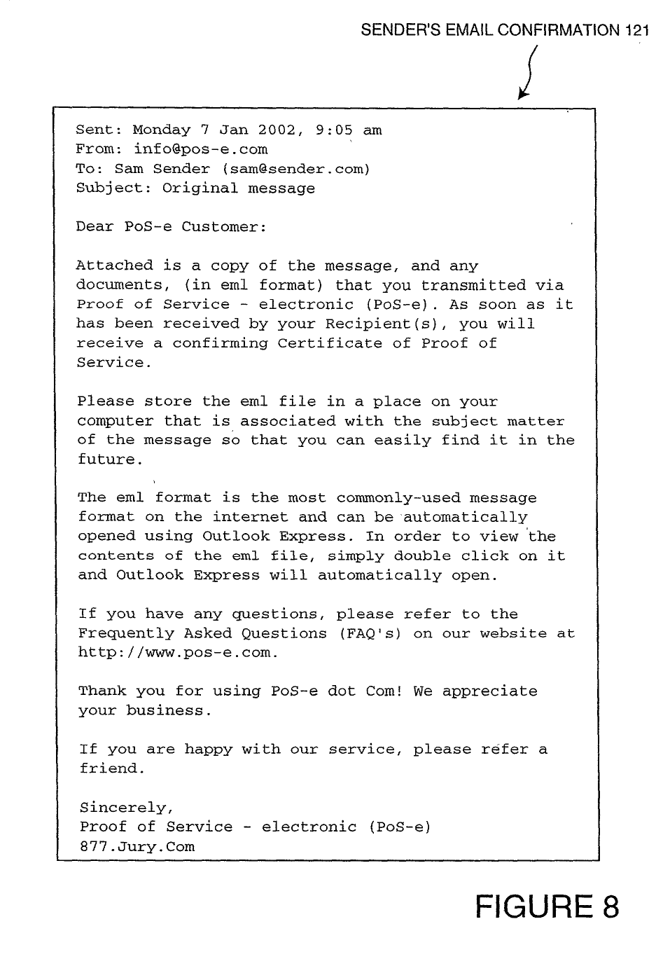

At step 156, the Server 100 sends an email confirmation 131 to the Sender indicating that the Electronic Package 20 has been received by the Server and is pending delivery to the recipient. FIG. 8 shows the format of the presently preferred email confirmation 131. At step 157, the Server 100 sends an email notification 130 to the Recipient 700 indicating that an Electronic Package 20 addressed to the Recipient is available on the Server 100. FIG. 9 shows the format of the presently preferred email notification 130.

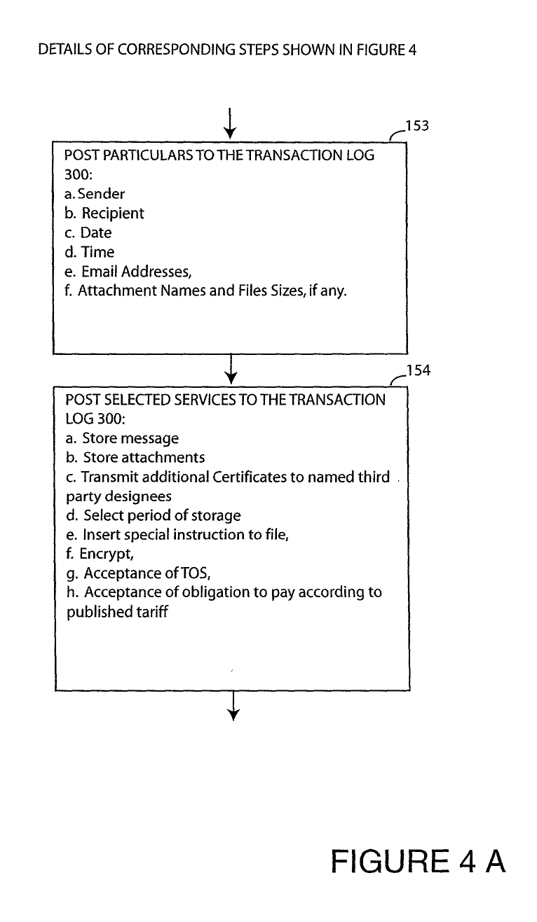

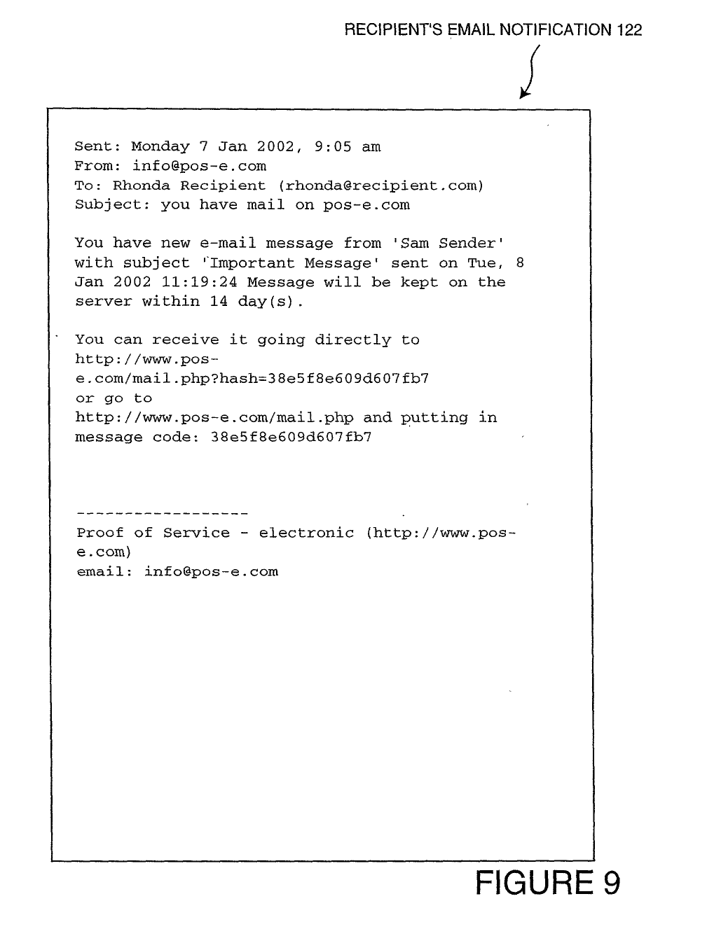

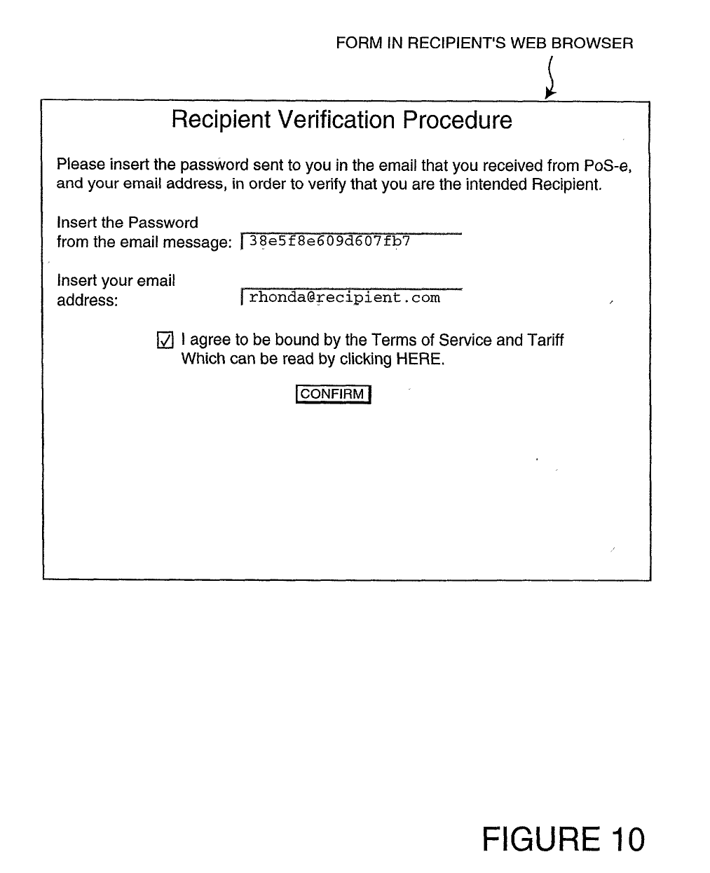

FIG. 5 shows the details associated with step 160 of FIG. 2, i.e. the delivery of the Electronic Package 20 to the Recipient 700. The Recipient 700 is hypothetically named Rhonda Recipient. At step 161, through her desktop, wireless, or other system 701 which is internet addressable, the Recipient 700 requests the web page that is identified by the hyperlink in the email notification 122 (see FIG. 9). Ideally, the Recipient simply follows the HTML link in the email notification 122, after which she simply enters her email. In case the Recipient's email client does not provide HTML services, an ALT function will describe the URL at which the Electronic Package 20 may be retrieved. The email notification 122 also contains, in addition to the URL, a message code or password generated for this particular transaction by Server 100. Using her email address and the password at the URL designated, the Recipient 700 may download the contents of the Electronic Package 20 that was prepared and transmitted by the Subscriber at step 143 and 144 of FIG. 3. At step 162, after the server sends the Recipient's client application the web page shown in FIG. 10, the Recipient enters her email address (e.g. “rhonda@recipient.com”) and, if necessary, the message code (if the Recipient clicked on the hyperlink that includes the message code in the HTML request, the Recipient will only be asked to enter her email address). At step 163, the Server 100 verifies the Recipient's authority to take delivery of the Electronic Package by comparing her email address and provided message code with corresponding data in the Transaction Log 300. The Server 100 then presents the Recipient 700 with a download page like that shown in FIG. 11. At step 164, if she chooses to continue, the Recipient 700 elects to take delivery of the Electronic Package by either downloading it with a Java applet, by downloading it directly, or by receiving it as an encrypted email attachment. The Java applet results in a standard eml file on the Recipient's system. If Recipient chooses on the other options, however, the file is encrypted before being transmitted to the Recipient and she must obtain a password from the Server 100 in order to access the eml file within the encrypted file. At step 165, the Server delivers the Electronic Package 20 to the Recipient according to her chosen means of delivery. At step 166, the Server logs the delivery particulars to the Transaction Log 300.

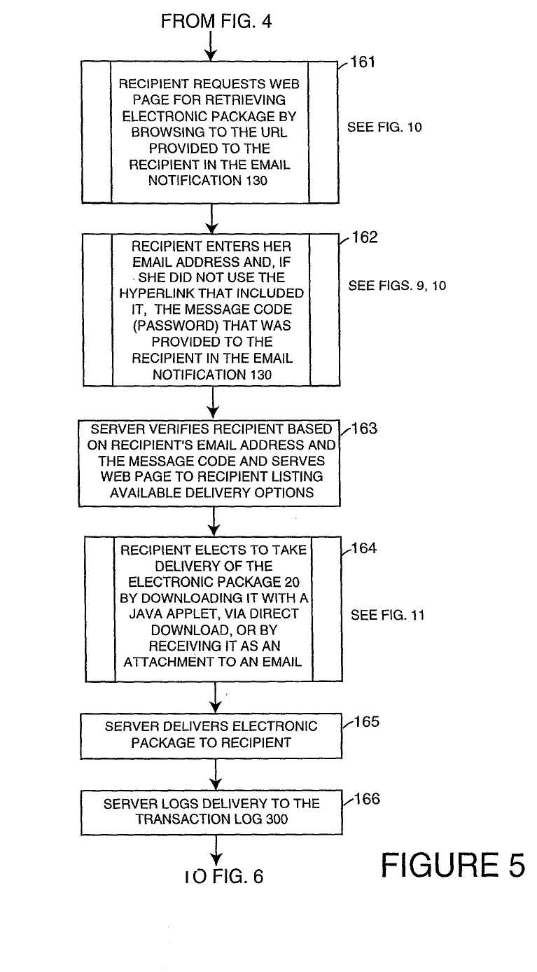

FIG. 6 shows the details associated with step 170 of FIG. 2, i.e. the creation and transmission of the Electronic Certificate of Service 110.

After the Recipient 700 takes delivery of the Electronic Package 20, and the Server logs such delivery to the Transaction Log (see steps 165 and 166 of FIG. 5), the Server 100 creates and transmits an Electronic Certificate of Service 110 to the Subscriber 600, the Recipient 700 and any other Sender selected designee 900 (the latter option is made possible at the bottom of FIG. 7). FIG. 6 shows a presently preferred method, but it is to be understood that this is but one embodiment out of a plurality of possible embodiments for the creation and transmission of the Electronic Certificate of Service 110.

At step 171, the Server 100 generates a hash value based on the delivery particulars 111 and the content particulars 112 associated with the Electronic Package 20 and then uses an “in camera key” maintained only by PoS-e to produce an encrypted hash value 120 for inclusion on the Electronic Certificate of Service, for storage, and for later verification of the transaction if so requested. A hash value, as is well known, is a number that is generated from a string of text using a formula that makes it extremely unlikely that some other text will produce the same hash value. Any suitable hash algorithm may be used provided that it meets the desired level of security.

At step 172, the Server 100 creates the Electronic Certificate of Service 110. The Certificate of Service 110 is created as an “electronic” Certificate in the sense that it is provided as a computer file and, more particularly, as an encrypted, printable file. The encrypted file will allow the file to be stored, copied, or printed at will; however, the encryption will not be susceptible to decryption without the In Camera Key 116 (herein sometimes the “ICK”) possessed solely by the Certifying Authority of PoS-e. FIG. 12 depicts a presently preferred format for the Electronic Certificate of Service 110. The preferred Electronic Certificate 110 is created as an encrypted pdf file so that it can be transported as an email attachment and readily viewed and printed but not modified.

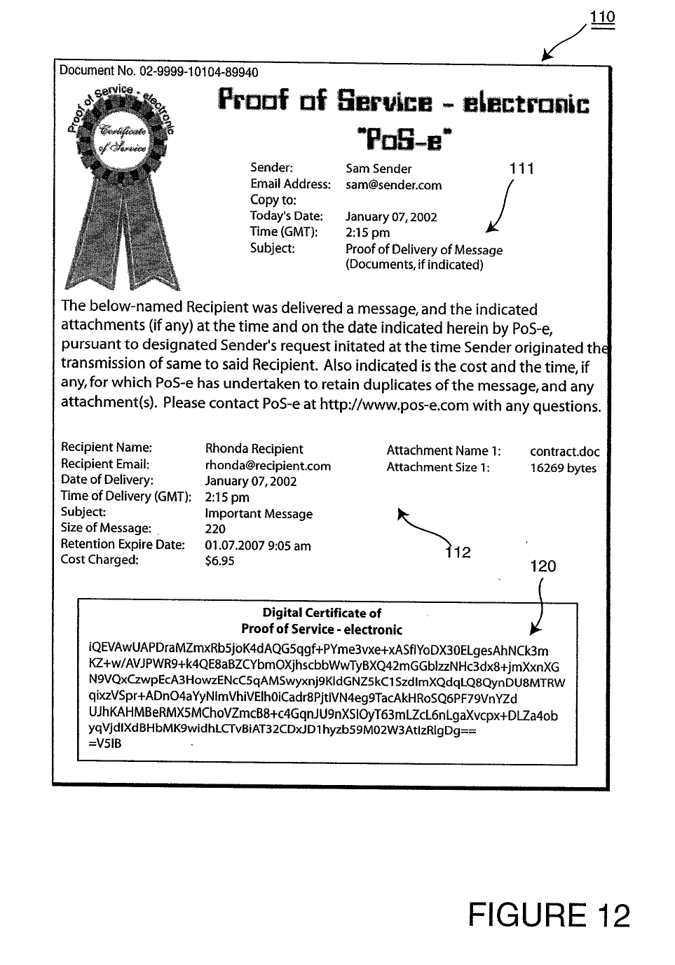

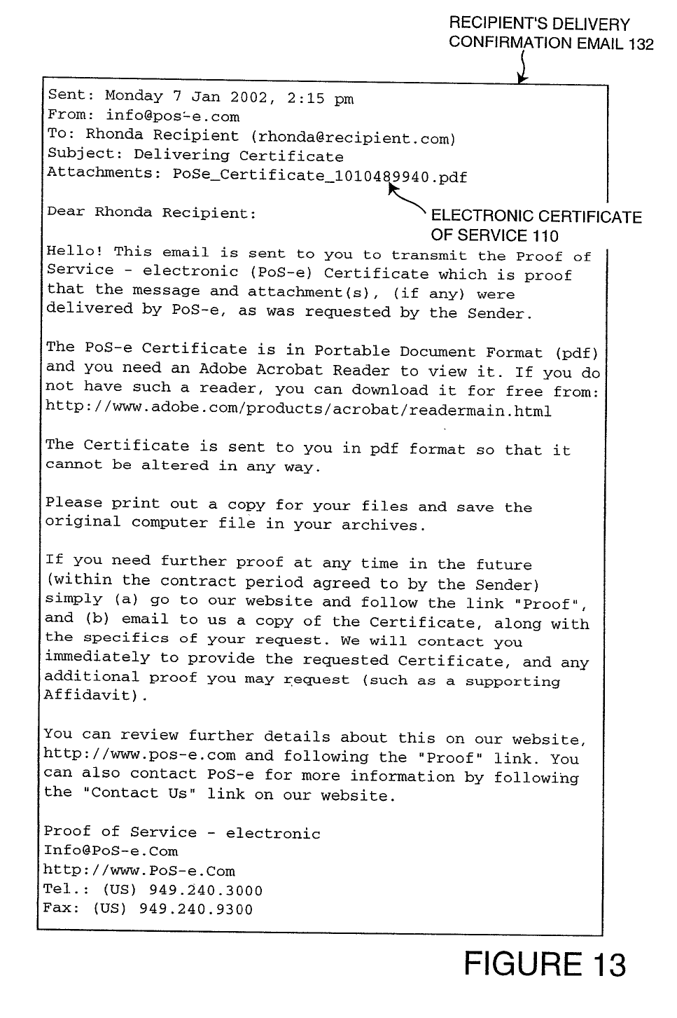

At step 173, the Server 100 transmits the Electronic Certificate of Service 110 to the Sender 600, the Recipient 700 and any Sender designees 900. FIGS. 13 and 14 show presently preferred email messages 131, 132, one to the Sender 600 and one to the Recipient 700, that transport the Certificate 110 as an attachment.

At this point, vis-à-vis the Sender and transaction, the responsibility under the TOS is completed insofar as PoS-e is concerned, unless there is received a Requisition from an Entitled Person as described further below.

The exemplar Form of Certificate 110 illustrated in FIG. 12 is one possible embodiment of such an Electronic Certificate and Physical Certificate out of a plurality of possible embodiments. It beneficially contains sufficient detail relating to the transmission particulars 111 and content particulars 112, as described herein and obtained through the Recipient verification process as to make it reasonably definite and certain. The “Digital Certificate of PoS-e” embedded in the Electronic Certificate will embody the ICK 116 so that the particular, if desired, may be recreated and verified if desired by reversing the encrypted has value 120.

### Future Query Process

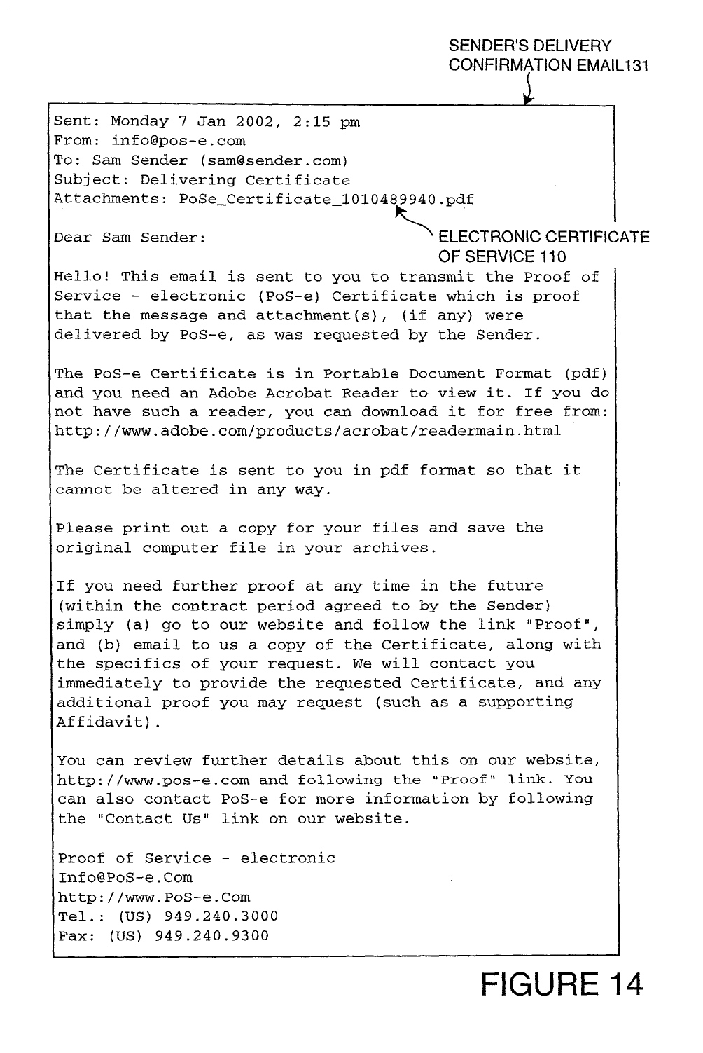

FIG. 15 shows the preferred Requisitioning processing suggested by the Future Query module 800 of FIG. 1. This functionality is to be provided because, at a future time unknown, but within the period agreed to by the Sender 600 pursuant to the provisions of the TOS and Services selection 604(e), an Entitled Party may Requisition a Physical Certificate to prove the transmission, or non-transmission, or an Electronic Package 20 (email message and attachment(s), if any).

At step 801, the Future Query process begins at step 801 when a Requisition is received. At step 802, appropriate personnel will verify that the Requisitioning Party is an Entitled Person and that the agreed-upon fees are submitted 802. At step 803, provided that the PoS-e personnel have received acceptable proof that the Requisitioning Party is an Entitled Person, the PoS-e personnel will prepare an affidavit certifying the particulars 112, 112 of the transaction, the accurateness of the data, if any, transmitted with the Electronic Package 20, and the chain of custody of such Electronic Package 20.

At the point, at step 804, when the designated personnel of PoS-e are sufficiently convinced that the details in any Electronic Certificate presented during the Requisitioning process for verification are true and correct, it will turn the said Electronic Certificate, Requisition, their own written proof of verification(s), and all duplicates of all Messages and Attachment(s), if any over to the Certifying Authority for its second level audit.

The Certifying Authority then, among other procedures to be decided upon by professionals competent in such matters, (a) compare the constitution of the original hash total with the constitution of the current hash total, (b) compare the name(s) of the attached file(s), if any, on the Storage Server with the name of the attachment(s), if any, on the original message log, (c) verify that the requesting party is a Subscriber, Recipient or Entitled Person, and (d) review the prepared affidavit for propriety after the findings thereof are further audited by (i) the Chief of Information Technology and (ii) Chief Operating Officer, as may be necessary or appropriate, and if found to be true and correct approve as an act and deed of PoS-e the said affidavit. The affidavit itself is then executed by the Custodian of Records.

Finally, at step 805, the affidavit is delivered to the Requisitioning Party pursuant to the TOS, with an duplicate thereof being retained by PoS-e, at which time the transaction is completed.

### Reverse Hash Process

At some point in the future an Entitled Person may wish to verify the particulars of a particular Electronic Package 20 or, in other words, verify the information that is represented in a particular Electronic Certificate of Service 110. This is preferably accomplished, at present, by simply having a Responsible Person locate the record related to the Electronic Package 20 in question and then reversing the encrypted hash value 120 and comparing it against that record.

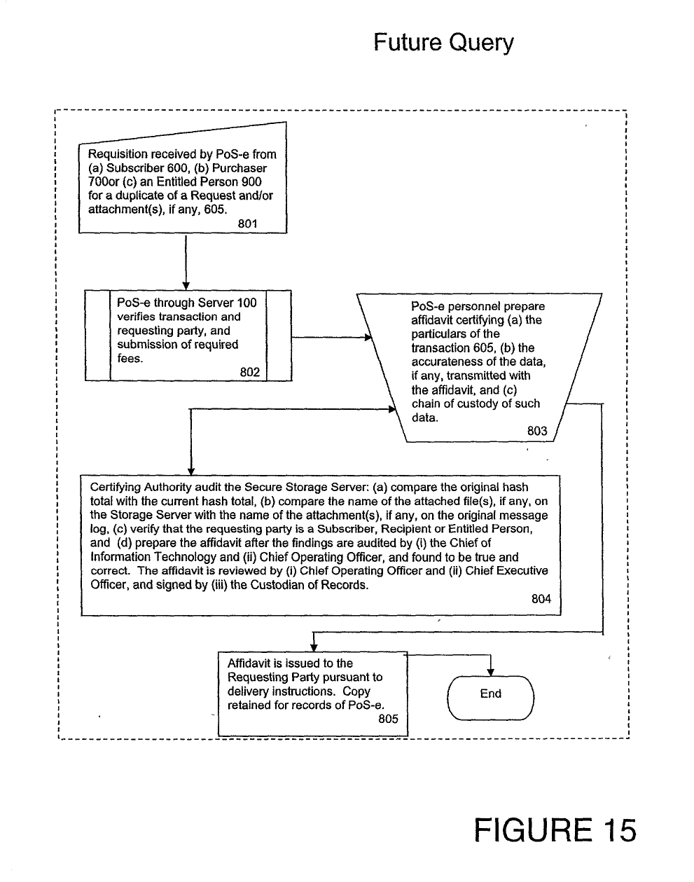

FIG. 16 shows the message search page that is presented when a Responsible Person searches for a particular Electronic Package that is to be verified. Here, the Responsible Person has used the Sender's name, “Sam Sender”, to identify only ony Electronic Package 20 that was assigned Certificate ID 88940. Note that this same Certificate ID appears on the top left of the Electronic Proof of Service 110 that was communicated to the Sender and Recipient.

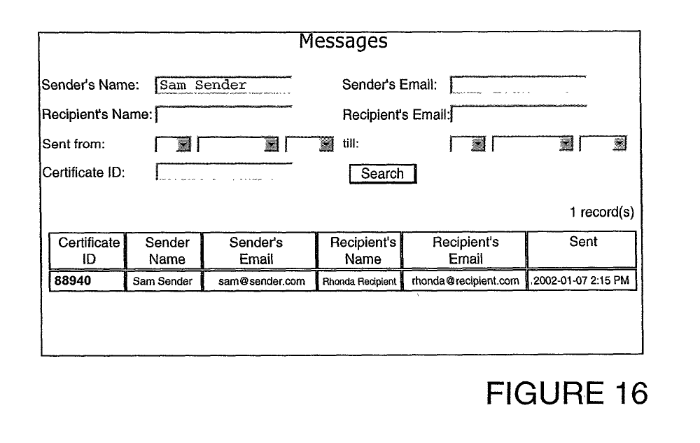

FIG. 17 shows the web page that is presented when a particular Certificate ID from the message search page of FIG. 16 is clicked. Here, the hypelink associated with Certificate ID 88940 was clicked. As shown, the web page includes a “signature checking” entry window into which the Responsible Person enters the encrypted hash value 120 provided by the Entitled Person who wishes to verify the Electronic Certificate of Service 110 and its represented particulars 111, 112.

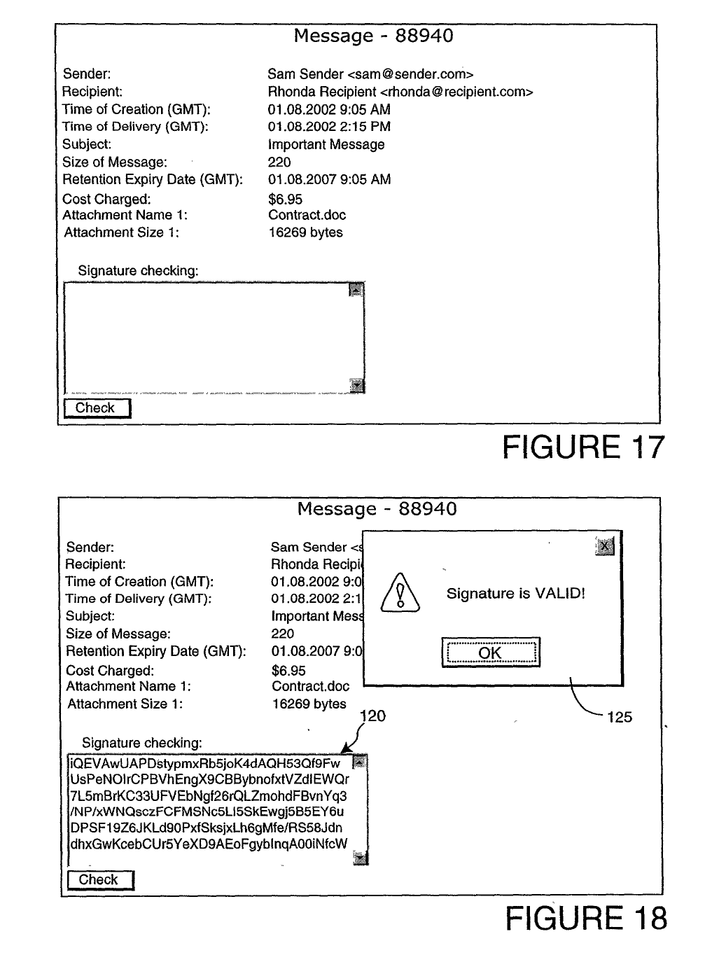

FIG. 18 shows the “Signature is VALID” notice that is displayed when a valid encrypted hash value 120 has been inserted in the “signature checking” entry window and the “Check” button depressed.

### Unitary Package Embodiment

Another aspect of the present invention is a method and system for Unitary-Action Submission and Transmission of EPs in a multiple stage environment. The Unitary-Action Submission and Transmission system of the present invention reduces the number of Sender interactions needed to Submit and Transmit EPs and reduces the amount of sensitive information that is transmitted between a Sender System and a server system.

In one embodiment, the server system 1000 assigns a unique Sender Identification Format (SIF) 1106 to each Sender 601 in the system. The server system also stores Sender-specific Submission 1101 information for various potential Organizations 1400. The Sender-specific Submission information 1101 may have been collected from a previous transaction transmitted by the Sender, referred to herein as a CORE 1105. The server system maps each Sender's SIF 1106 to a Sender that may use that Sender's System 1100 to complete a Submission and Transmission 1109. The Transaction so completed is sent via an Internet connection 606.

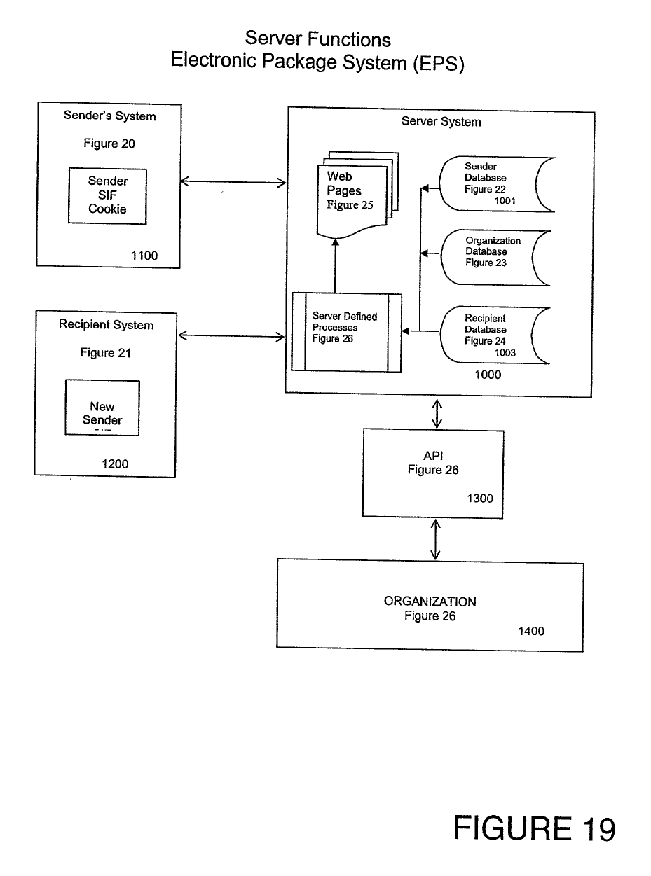

The server system may map the Sender's identifiers to the Sender who last transmitted a Submission using that information 1107. When a Sender wants to complete a Submission and Transmission, the Sender uses the herein system to transmit the specifics of the Submission and Transmission [FIG. 19].

The server system determines whether the SIF 1106 for that Sender is assigned 1107 and verifies by the SIF cookie 1107a/b on the Sender's system that the Sender has been identified as the particular Sender 1107. If so identified, the server system determines whether Unitary-Action Submission and Transmission is enabled for that Sender at that system 1107. If enabled 1107a, the server system performs the Submission and Transmission requested on FIG. 19. When Unitary-Action Submission and Transmission is enabled, the Sender only has to perform a Unitary action (e.g., click a mouse button, or provoke a sound) to submit with the Organization, and transmit to all named Recipients, all of the attachment(s) (if any) and the message set forth on Diagram 12 at 1109.

When the Sender performs that Unitary Action, the server system notifies the Sender's System 1100. The server system then completes the Transmission by adding the Sender-specific Submission and Transmission information (“CORE”) 1107b for the Sender that has been assigned to that SIF to the Transmission order information (e.g., Organization and/or Recipients) upon the election by Sender 1110. Thus, once the description of an Organization or Recipient, or both, is displayed, the Sender need only take a Unitary Action to complete the Transmission to either, or both 1107b.

Also, since the SIF 1106 identifies Sender-specific Transmission information already stored at the server system, there is no need for such sensitive information to be transmitted via the Internet or other communications medium. The present invention provides a method and system for Unitary-Action Transmission of EPs in a client/server environment. The Unitary-Action Transmission system of the present invention reduces the number of Sender interactions needed to submit and transmit an EP and reduces the amount of sensitive information that is transmitted between a Sender's System and a server system.

In one embodiment, the server system assigns a unique SIF 1106 to each Sender's System. The server system also stores Sender-specific Transmission, either in a CORE setting 1105, or in a Recipient Book 1103, storing information for various potential Recipients. The Sender-specific information may have been collected from a previous CORE Transmission completed by the Sender. The server system compiles each SIF to a Sender that may use that Sender's System to complete a Transaction, allowing the Unitary action to accomplish a plethora of “hidden” functions.

When the Sender performs that Unitary Action, the Sender's System notifies the server system 1107. The server system then completes the Submission and/or Transmission by adding the Sender-specific Transmission demand for the Sender that is compiled to that SIF to the designated Organization and/or Recipients 1109. Thus, once the array of the Organization and/or Recipient(s) is exhibited on FIG. 19, the Sender need only take a Unitary Action to complete both Submission and/or Transmission. Also, since the SIF identifies Sender-specific Transmission information already stored at the server system, there is no need for such sensitive information to be transmitted via the Internet or other communications medium.

In one embodiment of the present invention, a Recipient 1200 of an EP may have an anti-virus program (“AVP”) running on her computer at the time of receipt. If the Sender 1100 did not elect to render the files comprising the EP into a format not susceptible of porting a virus, for example pdf, it is entirely possible that a virus, worm, mole, or other harmful executable may be transferred embedded with a file, or files of the EP. At this point, the AVP may (and probably will) strip from the EP the affected file(s) from the EP upon delivery. To combat this possibility, the announcing and transporting email message 1203 will have a list of the files comprising the EP and a link that the Recipient can utilize to return to the Server. Upon determining that a file is missing 1204, the Recipient can return to the 1205 server 1000, and the insert either the Recipient's email address (if the Recipient is already a Registered User) or a server-generated hash (if the Recipient is not so Registered) 1206. Then Recipient 1200 can elect, via web page 1117, to receive the affected file in a format that does not port a malicious executable 1207 via an email 1203.

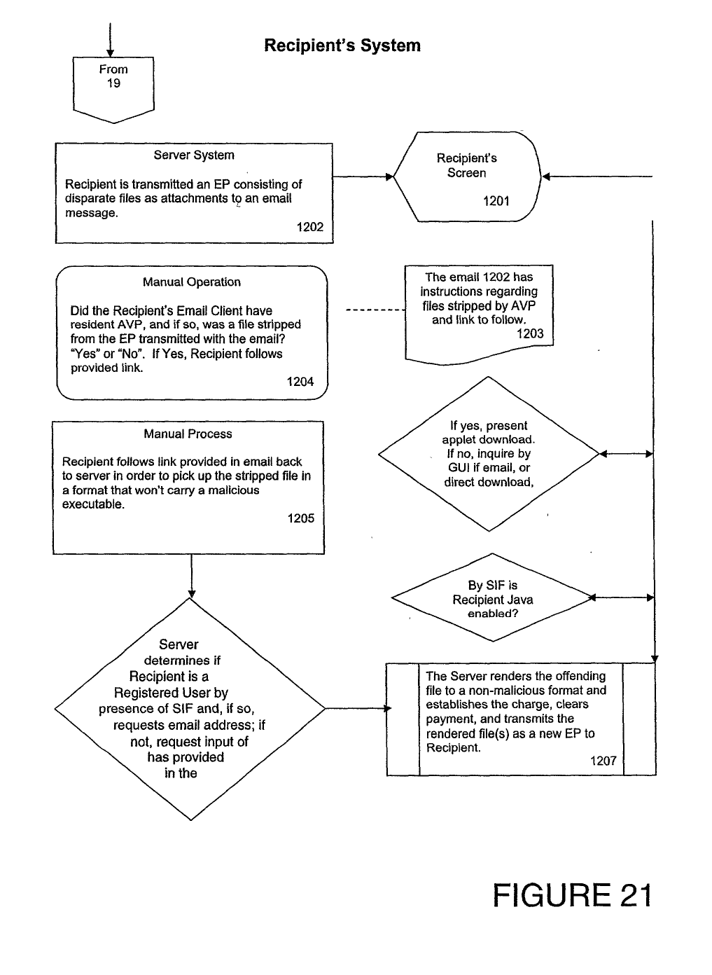

In one embodiment of the present invention, a unique and nonobvious system is set forth on FIG. 21 whereby the infected file may nevertheless be salvaged by the Recipient without input, or assistance of any type, from the Sender; and utilizing the SIF, said system 1207 can discern if the Recipient's computer operating system is java enabled (and thus utilize a proprietary applet-driven download of the file), or not and, if not, 1208 offer the Recipient the choice to receive the rendered file by direct download or through the email.

In one embodiment of the present invention, the Server System 1000 creates a Sender's Database 1101 unique to each Sender. In the database will be found such Personal Identifying Information (“Pll”) 1102 as name, address, telephone numbers, email address, any association references (such as a government license), affiliate relationships, and credit information. Also, the Sender is given access to a Recipient Book feature 1103 whereby Pll information about each Recipient (such as name, nickname, email address, etc.) can manually input a name at a time, or can be imported into the Sender's Database 1101 by internet transfer utilizing a file such as a CSV formatted text file. The said Recipient Book can be utilized to allocate Recipients into groups, facilitating preparation of CORE 1105 associations involving multiple Recipients. Similarly, multiple-associations can be prepared involving Organization(s). Upon completion of the Sender's Database, or accretion thereto by subsequent CORE associations, the Server System 1000 will set the SIF 1106 cookie on the Sender's computer for future use.

In one embodiment of the present invention, the Server System will present a plethora of possible Organizations, all of which are resident on the Server System 1401, via a web page 1113 while the Sender is at the Message Compose Page 1111 on her web browser 601. From the plethora of Organizations, the Sender can select one, or more Organizations 1400. At the same session, the Sender can select from the Recipient Book 1112 a plethora of options including (but not limited to) addition a Recipient(s) by manual input, selection of Recipient(s) already in the Recipient Book 1112, to aggregate the selected Recipient(s) into a specifically named group (whether or not any of said Recipient's are already a member of a pre-existing group), to import a new Recipient, or aggregation of Recipient(s) via upload in a text format such as CSV and incorporation thereof into said Recipient Book. After electing the Organization 1400 and the Recipient(s) 1112, the Sender can then instruct the Server System via the browser interface 601 to Submit and Transmit the uploaded EP to the respective Organization and Recipient(s). Immediately thereafter 1116, the Server System will request instructions from the Sender to accrete that particular Transaction as a CORE selection and, if granted, will place the selection into the ALN. Additionally, the Server System may receive instructions from the Sender to render the EP into an alternative format (such as pdf) either file-by-file, or aggregated into a single file 1114. Thereupon, the Transaction will be completed.

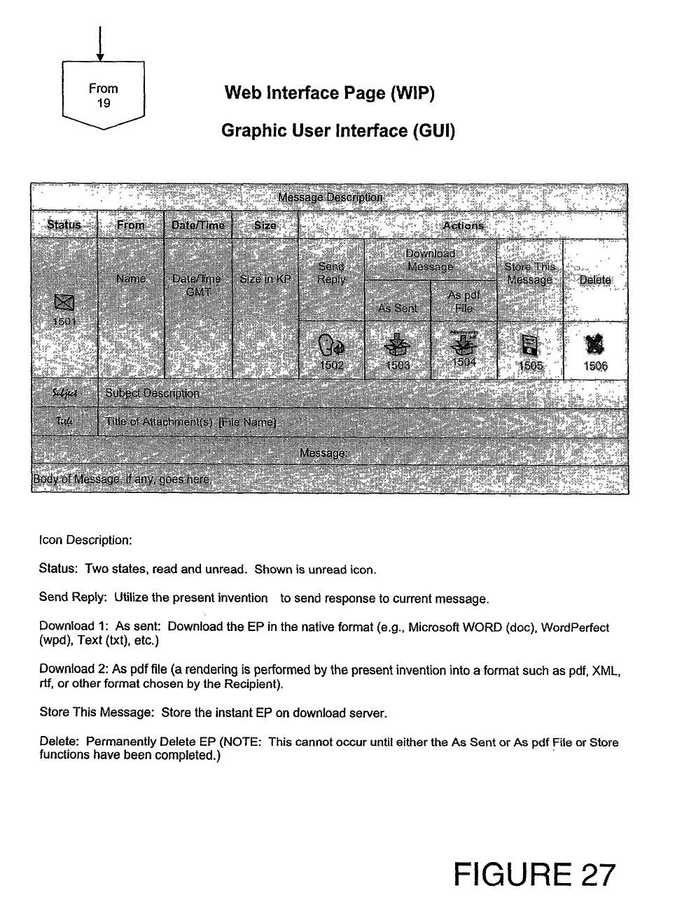

One embodiment of the present invention is found on FIG. 27, which is a graphical representation of a web page entitled Web Interface Page (“WIP”) employing unique and nonobvious messaging functions, as described in this paragraph. The WIP consists in one embodiment, out of a plethora of possible embodiments, of a web page with icons representing the status of a message (two states—read or unread), the availability to utilize the Server System for a reply Transaction, the availability to download the EP either in its native state (if Transmitted in that manner by the Sender) or in an alternative rendered format (e.g., pdf), to store the EP on the Server System of Applicant (in lieu of Recipient's local storage device), or to delete the EP, all as described in said FIG. 27.

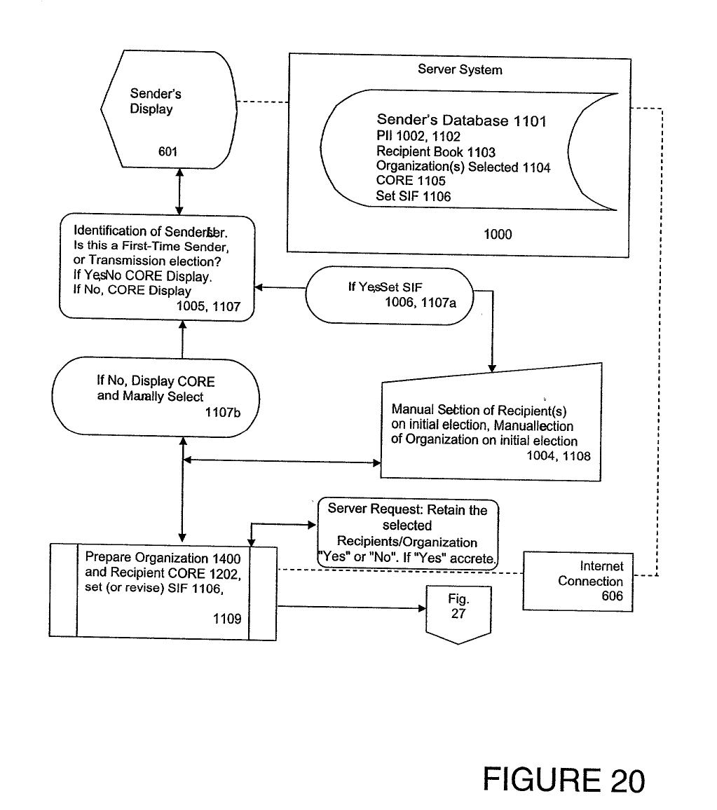

FIG. 20 is an illustration of the Sender's System including the SIF cookie

FIG. 21 is an illustration of the functioning of the Recipient System, including recapturing a stripped file

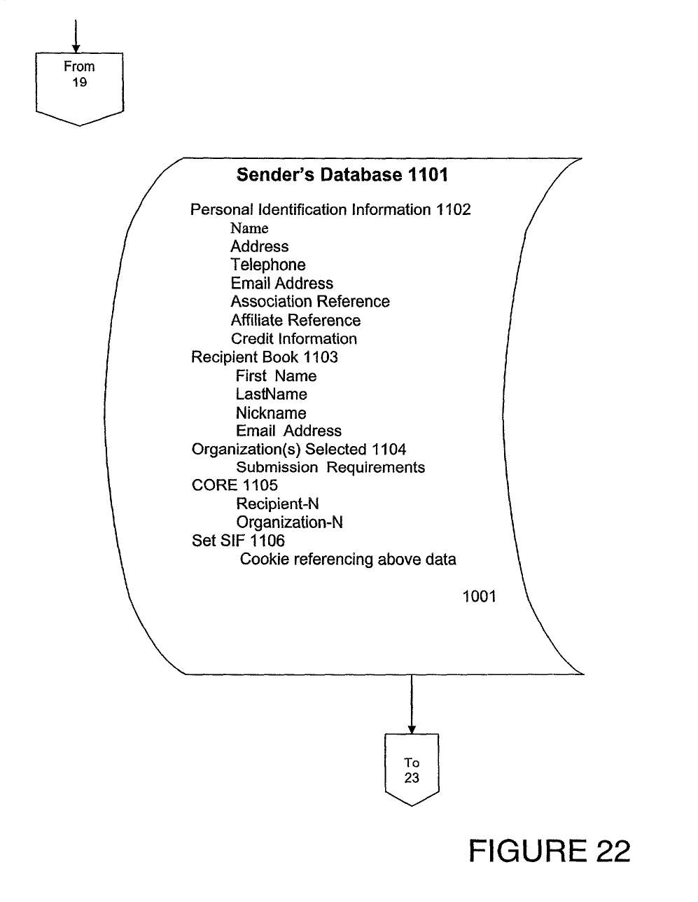

FIG. 22 is an illustration of the composition of the Sender's database requirements

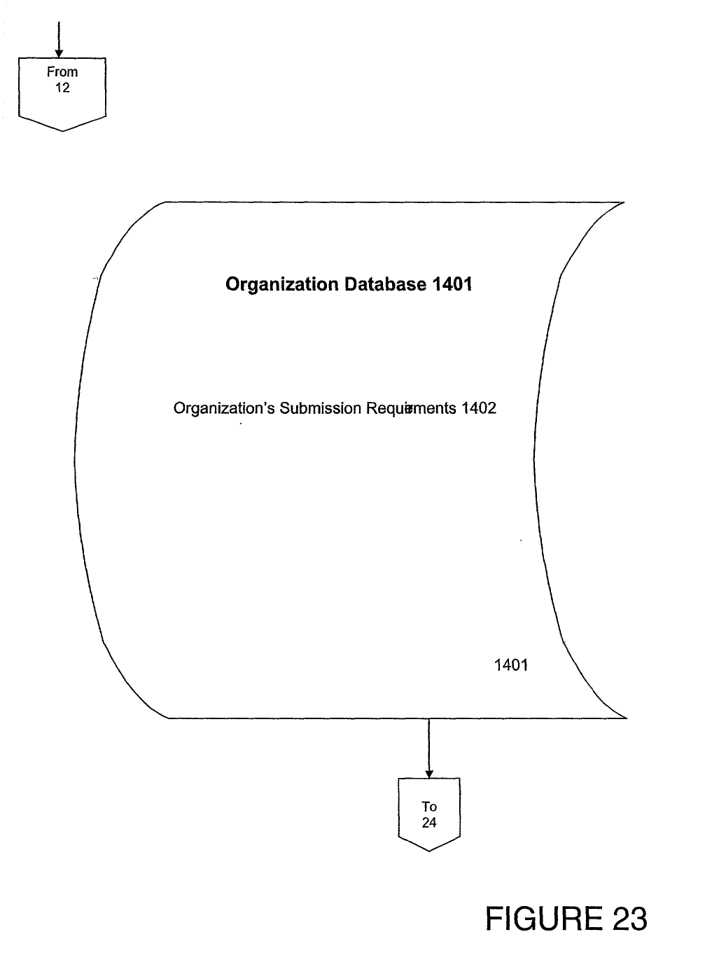

FIG. 23 is an illustration of the composition of the Organization database, insofar as known for any particular Organization

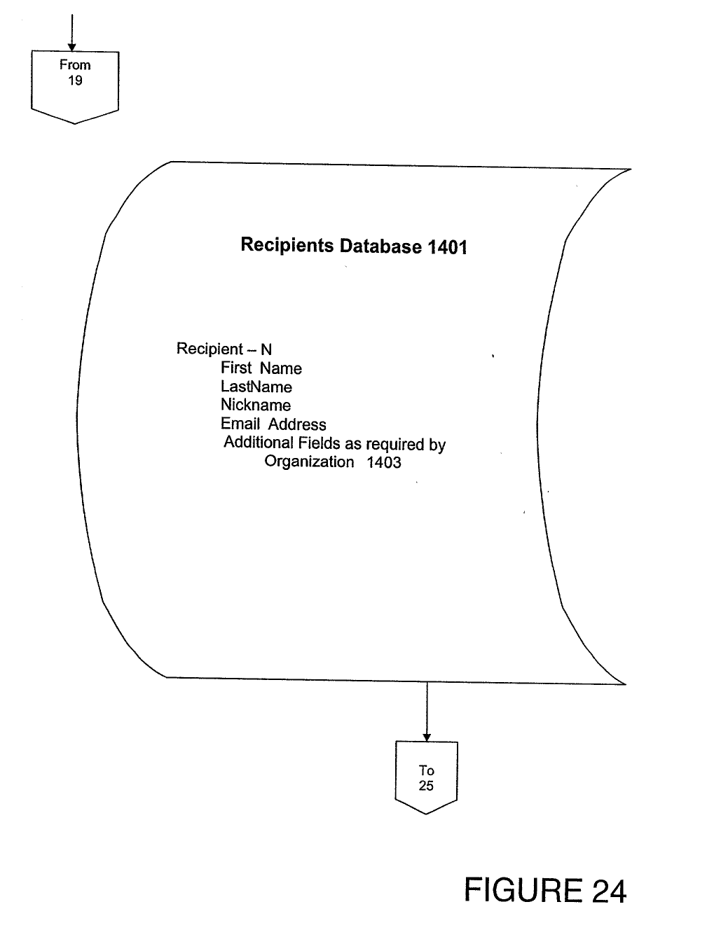

FIG. 24 is an illustration of the database requirements for the Recipient(s)

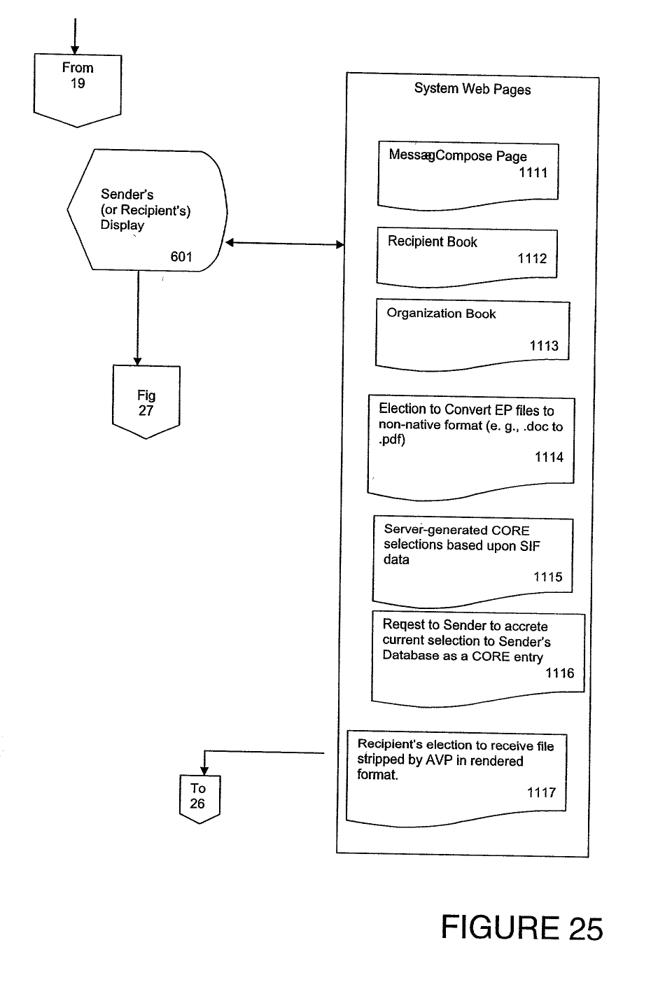

FIG. 25 is an illustration of the web pages of the EPS system

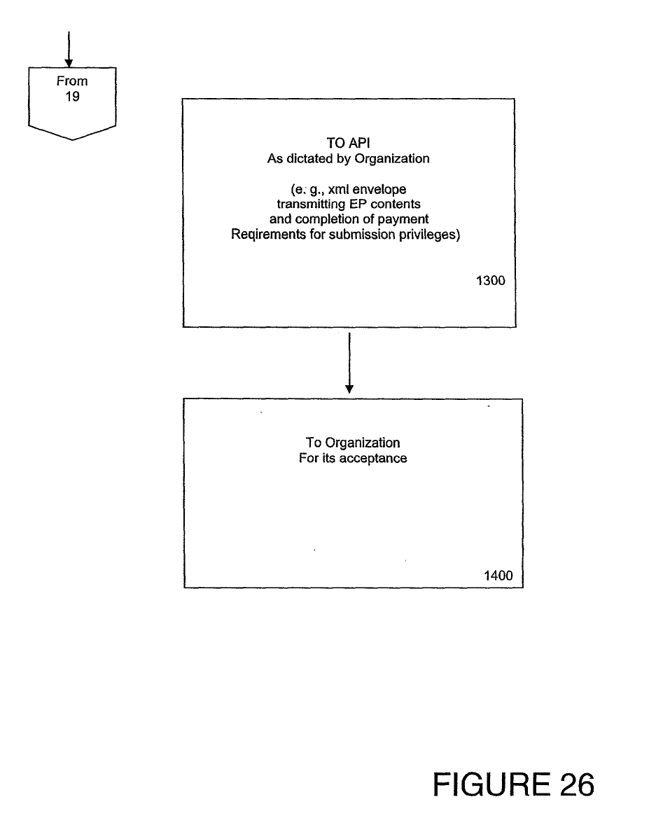

FIG. 26 is an illustration of the API and Organization interfaceSince numerous modifications and variations will readily occur to those skilled in the art, it is not desired that the present invention be limited to the exact construction and operation illustrated and described herein, and accordingly, all suitable modifications and equivalents which may be resorted to are intended to fall within the scope of the claims to be made under the protection afforded by this Application, and the same numerous modifications and variations shall be deemed to be included within the scope of this Application.

What it claimed is:

1. A method for verifiably transmitting an electronic package from a sender to a recipient through a certifying authority via a public communications network, the method comprising the steps of:
receiving an electronic package that is transmitted from the sender to the certifying authority via the public communications network;
storing particulars relating to the electronic package on a server operated by the certifying authority for use in later verifying the particulars relating to the electronic package;
delivering the electronic package from the certifying authority to the recipient via the public communications network;
generating an encrypted hash value based on the particulars relating to the electronic package and the delivery thereof, the encrypted hash value uniquely identifying the particulars relating to the electronic package and the delivery thereof; and
transmitting an electronic certificate of service from the certifying authority via the public communications network, the electronic certificate of service including the particulars relating to the electronic package and the encrypted hash value as verification of the content and delivery of the electronic package from the certifying authority to the recipient.

2. The method of claim 1 further comprising the step of storing the electronic package on the server operated by the certifying authority for use in later producing a duplicate of the electronic package.

3. The method of claim 1 wherein the electronic package comprises an email message.

4. The method of claim 3 wherein the electronic package further comprises an email attachment.

5. The method of claim 1 wherein the electronic package comprises a ascii file.

6. The method of claim 1 wherein the electronic package comprises a binary file.

7. The method of claim 1 wherein the particulars surrounding the electronic package comprises date and time of transmission.

8. The method of claim 1 wherein the particulars surrounding the electronic package comprises identity of sender and identity of recipient.

9. The method of claim 1 wherein the particulars surrounding the electronic package comprises an email address of sender and email address of recipient.

10. The method of claim 1 wherein the particulars surrounding the electronic package comprises maximum number of days within which to deliver the electronic package to the recipient.

11. The method of claim 10 further comprising the step of informing the sender, in event that delivery was not made to the recipient within the maximum number of days.

12. The method of claim 1 wherein the particulars surrounding the electronic package comprises a date through which the electronic package is to be stored by the certifying authority.

13. The method of claim 1 wherein tracked message includes an email message and an email attachment and wherein the particulars surrounding the electronic package comprises identity of sender, email address of sender, identity of recipient, email address of recipient, date of transmission, time of transmission, length of the email message, name of the email attachment, and size of the email attachment.

14. The method of claim 1 further comprising the steps of creating the electronic certificate of service as an encrypted file.

15. The method of claim 1 wherein the step of creating the electronic certificate of service as an encrypted file is accomplished by creating an encrypted PDF file that is printable but not modifiable.

16. The method of claim 1 further comprising the step of verifying an encrypted hash value that is questioned by
transmitting the encrypted hash value to the certifying authority; and
comparing the encrypted hash value that is questioned with records of the certifying authority.

17. The method of claim 1 further comprising the step of notifying the recipient via the public communications network that the electronic package is available for pickup from the server operated by the certifying authority

18. The method of claim 16 wherein the step of delivering the electronic package from the certifying authority to the recipient via the public communications network occurs upon a request for download thereof by the recipient; and wherein the step of transmitting an electronic certificate of service from the certifying authority via the public communications network takes place after completion of the delivering step.

19. The method of claim 1 wherein the step of delivering the electronic package from the certifying authority to the recipient is legally presumed by virtue of sending the electronic package to a valid email address associated with the recipient.

20. The method of claim 1 wherein the step of transmitting an electronic certificate of service transmits an electronic certificate of service to the sender.

21. The method of claim 1 wherein the step of transmitting an electronic certificate of service transmits an electronic certificate of service to the recipient.

22. The method of claim 1 wherein the step of transmitting an electronic certificate of service transmits an electronic certificate of service to a designee of the sender other than the recipient.
